(19) United States
(12) Patent Application Publication
(10) Pub. No.: US 2026/0040393 A1
(43) Pub. Date: Feb. 5, 2026

(54) ENHANCED MANAGEMENT OF DISCONTINUOUS RECEPTION

(71) Applicant: Dell Products L.P., Round Rock, TX (US)

(72) Inventors: Satish Venkob, Mississauga (CA); Arjun Nandyal, Kanata (CA)

(21) Appl. No.: 18/795,071

(22) Filed: Aug. 5, 2024

(51) Int. Cl. H04W 76/28; H04L 43/0852

(52) U.S. Cl. CPC H04W 76/28; H04L 43/0852

(57) ABSTRACT

Management of DRX configuration for a device can be enhanced. DRX manager can determine a data traffic arrival pattern of data traffic associated with a device based on analysis of data traffic. Based on the data traffic arrival pattern and PDB associated with data traffic, DRX manager can control, via a MAC CE value or DCI value, DRX parameters to control DRX pattern associated with data traffic. If DRX manager determines that modification of duration of long DRX cycle, enabling or disabling of short DRX cycle, and/or modification of DRX inactivity timer can reduce power consumption of device while satisfying PDB, DRX manager can, via communication of the MAC CE value or DCI value to device, control DRX parameters to modify duration of long DRX cycle, enable or disable of short DRX cycle, and/or modify DRX inactivity timer.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise determining, by a system comprising at least one processor, a data traffic arrival pattern of data traffic associated with a device based on an analysis of the data traffic. The method also can comprise: based on the data traffic arrival pattern of the data traffic and a packet delay budget value associated with the data traffic, controlling, by the system, via a medium-access-control (MAC) control element (CE) value or a downlink control information (DCI) value, a discontinuous reception parameter to control a discontinuous reception pattern associated with the data traffic.

In certain embodiments, the disclosed subject matter can comprise a system that can comprise at least one memory that can store computer executable components, and at least one processor that can execute computer executable components stored in the at least one memory. The computer executable components can comprise a data pattern analyzer that can determine a data traffic pattern of data traffic associated with a user equipment (UE) based on a result of an analysis of the data traffic. The computer executable components also can comprise a discontinuous reception manager that, based on the data traffic pattern and a packet delay budget value associated with the data traffic, can manage, via a MAC CE value or a DCI value, a discontinuous reception parameter to manage a discontinuous reception pattern associated with the data traffic.

In still other embodiments, the disclosed subject matter can comprise a non-transitory machine-readable medium, comprising executable instructions that, when executed by at least one processor, can facilitate performance of operations. The operations can comprise determining a data traffic arrival pattern of data traffic associated with a UE based on a result of an analysis of the data traffic. The operations also can comprise: based on the data traffic arrival pattern of the data traffic and a packet delay budget value associated with the data traffic, controlling, via a MAC CE value or a DCI value, a discontinuous reception parameter to control a discontinuous reception pattern associated with the data traffic.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage discontinuous reception (DRX) associated with devices to achieve desirable communication performance and power savings, in accordance with various aspects and embodiments of the disclosed subject matter.

FIG. 2 depicts a block diagram of a non-limiting example DRX manager component that can desirably manage DRX associated with devices to achieve desirable communication performance and power savings, in accordance with various aspects and embodiments of the disclosed subject matter.

FIG. 3 illustrates a block diagram of a non-limiting example enhanced medium access control (MAC) control element (CE) (MAC CE) that can be utilized to manage parameters associated with a long DRX cycle, in accordance with various aspects and embodiments of the disclosed subject matter.

FIG. 4 depicts a block diagram of a non-limiting example enhanced MAC CE that can be utilized to manage parameters associated with a short DRX cycle, in accordance with various aspects and embodiments of the disclosed subject matter.

FIG. 5 illustrates a block diagram of a non-limiting example enhanced MAC CE that can be utilized to manage parameters associated with a DRX inactivity timer, in accordance with various aspects and embodiments of the disclosed subject matter.

FIG. 6 illustrates a diagram of a non-limiting example scenario relating to communication of data traffic, comprising video, to a device using a configured DRX pattern where modification of DRX pattern, using MAC CE and/or downlink control information (DCI), can satisfy a packet delay budget (PDB) associated with the data traffic and reduce power usage by the device, in accordance with various aspects and embodiments of the disclosed subject matter.

FIG. 7 depicts a diagram of a non-limiting example scenario relating to communication of data traffic, comprising video, to the device using a configured DRX pattern where modification of the configured DRX pattern, using MAC CE and/or DCI, to disable the short DRX cycle can satisfy the PDB associated with the data traffic and reduce power usage by the device, in accordance with various aspects and embodiments of the disclosed subject matter.

FIG. 8 illustrates a diagram of a non-limiting example scenario relating to communication of data traffic, comprising voice data traffic, to the device using a configured DRX pattern where modification of the configured DRX pattern, using MAC CE and/or DCI, to modify the long DRX cycle, enable the short DRX cycle, or modify the DRX inactivity timer can satisfy the PDB associated with the data traffic and reduce power usage by the device, in accordance with various aspects and embodiments of the disclosed subject matter.

FIG. 9 depicts a diagram of a non-limiting example DRX management flow process relating to desirable management of DRX in connection with communication of data traffic, comprising video data traffic, to the device, in accordance with various aspects and embodiments of the disclosed subject matter.

FIG. 10 illustrates a diagram of a non-limiting example DRX management flow process relating to desirable management of DRX in connection with communication of data traffic, comprising voice data traffic, to the device, in accordance with various aspects and embodiments of the disclosed subject matter.

FIG. 11 illustrates a block diagram of non-limiting example network components that can introduce certain delays that can be associated with (e.g., can affect) the PDB associated with data traffic associated with a device and determination of a remaining PDB associated with the data traffic that can take into account such delays in connection with managing DRX parameters, in accordance with various aspects and embodiments of the disclosed subject matter.

FIG. 12 depicts a block diagram of non-limiting example DRX cycle modification process for modification of a long DRX cycle period, associated with data traffic associated with a device, that can be based at least in part on a remaining PDB associated with the data traffic that can take into account network delay components that can reduce the PDB to the remaining PDB, in accordance with various aspects and embodiments of the disclosed subject matter.

FIG. 13 depicts a block diagram of non-limiting example system that can comprise a DRX manager component in an open radio access network (O-RAN) communication network environment to facilitate desirable management of DRX associated with devices to achieve desirable communication performance and power savings, in accordance with various aspects and embodiments of the disclosed subject matter.

FIG. 14 depicts a diagram of a non-limiting example base station that can desirably facilitate connections and communication of information associated with devices, in accordance with various aspects and embodiments of the disclosed subject matter.

FIG. 15 illustrates a diagram of a non-limiting example device that can be operable to engage in a system architecture that facilitates wireless communications according to one or more embodiments described herein, in accordance with various aspects and embodiments of the disclosed subject matter.

FIG. 16 illustrates a flow chart of an example method that can desirably manage DRX associated with a device to achieve desirable communication performance and power savings, in accordance with various aspects and embodiments of the disclosed subject matter.

FIG. 17 depicts a flow chart of an example method that can desirably manage DRX associated with a device, including managing modification of a long DRX cycle and/or short DRX cycle associated with data traffic associated with the device, to achieve desirable communication performance and power savings, in accordance with various aspects and embodiments of the disclosed subject matter.

FIG. 18 illustrates a flow chart of another example method that can desirably manage DRX associated with a device, including managing disabling of a short DRX cycle associated with data traffic associated with the device, to achieve desirable communication performance and power savings, in accordance with various aspects and embodiments of the disclosed subject matter.

FIG. 19 depicts a flow chart of another example method that can desirably manage DRX associated with a device, including managing modification of a short DRX cycle and/or a DRX inactivity timer associated with data traffic associated with the device, to achieve desirable communication performance and power savings, in accordance with various aspects and embodiments of the disclosed subject matter.

FIG. 20 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to enhanced management of discontinuous reception (DRX) associated with devices (e.g., wireless devices, such as user equipment (UE)) to achieve desirable (e.g., suitable, enhanced, or optimal) communication performance, network performance, and power savings (e.g., reduction in use of battery power or other power by devices). In 5th generation (5G) new radio (NR), one of the existing power saving mechanisms for devices includes a feature known as connected mode DRX, which, in short, can be referred to as DRX. In DRX, in the connected mode, the communication network and the device can come to (e.g., negotiate) an agreement to having periods of inactivity or no scheduling. During these inactivity periods, the device does not have to monitor a physical in downlink control channel (PDCCH) between the device and the communication network, which can thereby save (e.g., reduce) power usage and/or the battery of the device.

In DRX, there can be two types of DRX cycles, a long DRX cycle and a short DRX cycle. Short DRX cycles can occur within (e.g., in between) long DRX cycles and optionally can be configured, if and as desired. If short DRX cycles are configured, the device can utilize the short DRX cycles to monitor PDCCH during inactive periods of the long DRX cycles (e.g., in between long DRX cycles). Both long and short DRX cycles can comprise on and off periods, where a receiver of the device can be turned on and off correspondingly. If no data activity (e.g., no PDCCH for the device) is observed by the device during the long DRX on period, the short DRX activity does not happen (e.g., there can be no on period as part of the short DRX cycle). If there is activity (e.g., PDCCH for the device) during the long DRX on period, the short DRX cycle (e.g., the short DRX cycle following that long DRX cycle) also can have an on period. A short DRX cycle can always be an integer multiple of the long DRX cycle.

With existing techniques, the on durations and off durations for both long DRX cycles and short DRX cycles, the respective lengths of the long DRX cycles and the short DRX cycles, the DRX inactivity time period after receiving PDCCH, and a start location (e.g., at subframe and slot level) can be configured as part of radio resource control (RRC) signaling from a radio access network (RAN) (e.g., a central unit (CU)-user plane (UP) of the RAN), as per existing 3^{rd} Generation Partnership Project (3GPP) specifications. Existing techniques for configuring or reconfiguring DRX parameters (e.g., on and off durations for long DRX cycles and short DRX cycles, respective lengths of long DRX cycles and short DRX cycles, DRX inactivity time period, the start location, and/or other DRX parameters) using RRC signaling can be undesirable, deficient, and inefficient.

For instance, different quality of service (QoS) and 5G QoS identifier (5QI) flows can have different packet delay budget (PDB) conditions (e.g., constraints, specifications, or requirements). Also, data arrival patterns of data arriving at a device can be somewhat irregular and often can change. Based on the data arrival patterns (e.g., data bursts) of data arriving at the device, using existing techniques for changing DRX, such as RRC signaling, to change (e.g., adapt) the configured DRX pattern can be undesirably inefficient. For example, for non-conversational video data traffic (e.g., buffered streaming video content) with a PDB of 300 milliseconds (ms) (e.g., with a net end-to-end delay of 280 ms from a source to a destination of a data packet), conversational voice data traffic with a PDB of 100 ms, and conversational video data traffic with a PDB of 150 ms (e.g., with a net end-to-end delay of 130 ms), different DRX patterns can be desirable (e.g., wanted or necessary) to account for the different PDBs. Reconfiguration of the DRX using RRC signaling can involve (e.g., entail or require) undesirable (e.g., unacceptable, inefficient, or suboptimal) latencies of hundreds of milliseconds to even seconds. That is, existing techniques using RRC signaling to reconfigure DRX parameters or enable or disable DRX cycles can have undesirably longer latencies and longer reaction times for devices to adapt DRX cycles with regard to incoming data arrival patterns (e.g., which can be changing or irregular data arrival patterns) for different QoS flows, which can lead to undesirably higher power consumption by the devices. Further, if a CU-control plane (CP) of the RAN is not co-located at the cell site, and is instead located at a central remote site or other more remote location, even larger latencies can occur during reconfiguration of the DRX using RRC signaling. Such latencies (e.g., delay) can cause the device to undesirably keep its receiver on (e.g., monitoring for the PDCCH) and use power (e.g., battery power or other power) when it otherwise would not have to in order to monitor for the PDCCH, which can lead to higher power consumption by the device.

The disclosed subject matter can address and overcome the aforementioned deficiencies and other deficiencies of such existing techniques with regard to managing DRX for devices, including management of configuration or reconfiguration of DRX parameters associated with devices. To that end, techniques that can desirably (e.g., automatically, dynamically, suitably, reliably, efficiently, enhancedly, and/or optimally) manage DRX associated with devices to achieve desirable communication performance and power savings are presented. A system can comprise a communication network that can comprise one or more RANs. A RAN can comprise one or more base stations that can facilitate communication (e.g., wireless communication) of data between devices associated with the communication network (e.g., communicatively connected to a base station of the communication network, or otherwise connected to the communication network).

The communication network can comprise a DRX manager component that can desirably manage DRX associated with devices to achieve desirable communication performance and power savings, in accordance with defined DRX management criteria. In accordance with various embodiments, the DRX manager component, in addition to employing RRC signaling, can employ medium access control (MAC) control element (CE) items (e.g., MAC CE values) and/or downlink control information (DCI) items (e.g., DCI values) to control and modify DRX parameters, including enabling or disabling DRX cycles, wherein the MAC CE items and DCI items can more quickly modify (e.g., can be faster in modifying) the DRX parameters than RRC signaling. In some embodiments, the DRX manager component can utilize DCI signaling (e.g., Layer 1 DCI signaling) as a faster mechanism (e.g., a mechanism that can be faster than RRC signaling) to enable or disable DRX cycles (e.g., short DRX cycles or long DRX cycles). For instance, the DRX manager component can utilize one bit in the DCI to control enabling and disabling of the DRX cycles.

In certain embodiments, the DRX manager component can determine a data arrival pattern (e.g., a data traffic arrival pattern) of data traffic associated with a device based at least in part on results of an analysis of the data traffic. The DRX manager component also can know or determine the PDB associated with the data traffic. Based at least in part on the data arrival pattern and the PDB associated with the data traffic (e.g., a remaining portion of the PDB), the DRX manager component can control, via a MAC CE value or DCI value, one or more DRX parameters to control a DRX pattern associated with the data traffic, wherein the DRX pattern can relate to long DRX cycles, short DRX cycles, DRX inactivity timers, and/or other DRX parameters. For instance, if the DRX manager component determines that modification (e.g., adjustment or reconfiguration) of a duration of long DRX cycle, enabling a short DRX cycle (if the short DRX cycle was disabled), or disabling the short DRX cycle (if the short DRX cycle was enabled), modification of a DRX inactivity timer, and/or modification of another DRX parameter can reduce power consumption of the device while still satisfying the PDB associated with the data traffic, and/or can satisfy the PDB if and when the PDB was not being satisfied, the DRX manager component can, via communication of the MAC CE value or DCI value to the device, control the one or more DRX parameters to modify the duration of long DRX cycle, enable the short DRX cycle (e.g., enable the disabled short DRX cycle), disable the short DRX cycle (e.g., disable the enabled short DRX cycle), modify the DRX inactivity timer, and/or modify the other DRX parameter, such as described herein.

The disclosed subject matter, by employing the DRX manager component and the techniques described herein, can desirably (e.g., automatically, dynamically, suitably, reliably, efficiently, enhancedly, and/or optimally) manage DRX (e.g., DRX parameters) associated with devices to reduce power (e.g., battery power or other power) consumption by the devices, enhance performance of devices, and enhance performance of the communication network, as compared to existing techniques for managing DRX.

These and other aspects and embodiments of the disclosed subject matter will now be described with respect to the drawings.

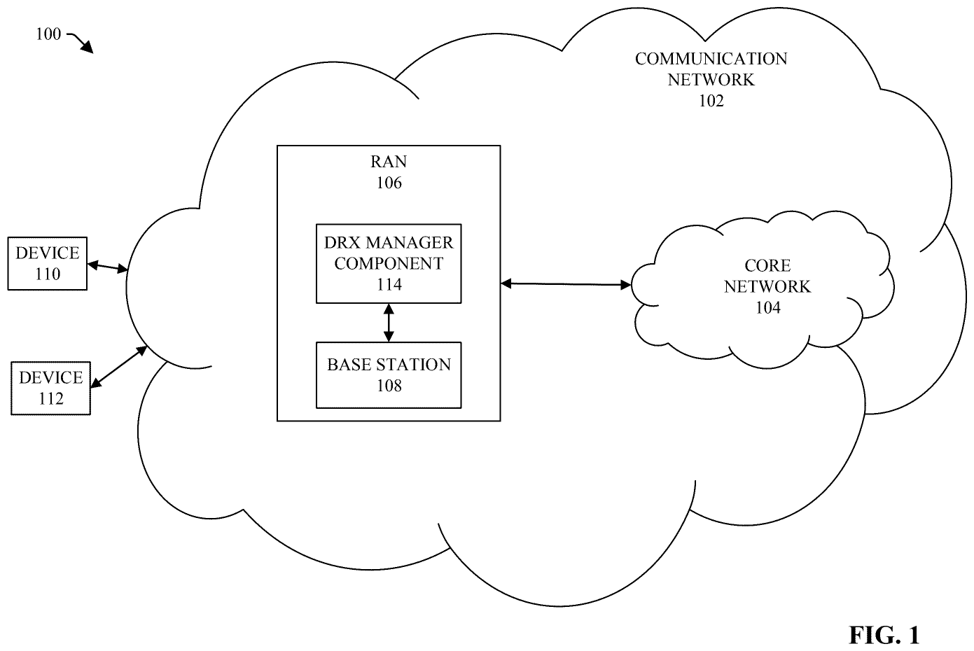

Referring now to the drawings, FIG. 1 illustrates a block diagram of a non-limiting example system 100 that can desirably (e.g., automatically, dynamically, suitably, reliably, efficiently, enhancedly, and/or optimally) manage DRX associated with devices to achieve desirable communication performance and power savings, in accordance with various aspects and embodiments of the disclosed subject matter. The system 100 can comprise a communication network 102 that can comprise a core network 104 and one or more radio access networks (RANs), such as RAN 106, that can be associated with (e.g., communicatively connected to) the core network 104. Each RAN (e.g., RAN 106) can comprise one or more base stations, such as, for example, base station 108, that each can comprise one or more cells (not shown in FIG. 1).

The core network 104, the one or more RANs (e.g., RAN 106), the one or more base stations (e.g., base station 108), and the one or more cells can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104).

The devices can comprise, for example, devices 110 and/or 112. A device (e.g., 110 or 112) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term UE can be used to describe the device. The device (e.g., 110 or 112) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) (e.g., base station 108) can be a 5G or other NR base station (e.g., gNB or other NR-type or xG base station, wherein x can be a number greater than 5). In some embodiments, the RAN 106 can be an open-RAN (O-RAN) that can be part of an O-RAN architecture and environment (e.g., the communication network 102 can employ an O-RAN architecture and environment). In certain embodiments, the core network 104 can comprise a user plane function (UPF) node, an access and mobility management function (AMF) node, and/or other network functions (not shown in FIG. 1 for reasons of brevity and clarity). The UPF node can connect to or interface with the one or more RANs (e.g., RAN 106) and the one or more base stations (e.g., base station 108), can be an interconnect point between the core network 104 and a data network (DN), can provide or facilitate providing a protocol data unit (PDU) session anchor point for providing mobility associated with radio access technologies (RATs), can provide or facilitate providing data packet routing or forwarding, and/or can perform or manage other functions. The AMF node can be a control plane function that can manage registration and deregistration of devices (e.g., devices 110 and/or 112) with the core network 104, manage connections of devices with the core network 104, manage mobility associated with devices (e.g., maintain knowledge of locations of devices, update locations of devices), and/or manage or perform other functions. In accordance with various other embodiments, the RAN(s) (e.g., RAN 106) and/or the base station(s) (e.g., base station 108) can be a 4^{th} generation (4G) long term evolution (LTE) RAN or base station, or the RAN or base station can comprise 4G LTE technology and functions, and 5G or other NR-type or xG technology and functions.

The communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 110 and/or 112) and the communication network 102. The communication network 102, including the core network 104, can provide or facilitate wireless or wireline communication connections and channels between the one or more devices (e.g., devices 110 and/or 112), and/or respectively associated services or applications, and the communication network 102. For reasons of brevity or clarity, some of the various network equipment, components, functions, or devices of the communication network may not be explicitly shown or described herein.

At various times, the respective devices (e.g., devices 110 and/or 112) can utilize respective services. The services can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

As disclosed, some existing techniques that employ RRC signaling for modifying DRX can be deficient and undesirable in a number of ways, including that such existing techniques can be undesirably slow (e.g., can have an undesirably high amount of latency) in modifying DRX parameters and can cause devices to consume and undesirable amount of power (e.g., battery power or other power).

The disclosed subject matter can overcome these deficiencies and other problems of existing techniques. To that end, the system 100 can comprise a DRX manager component 114 that desirably (e.g., automatically, dynamically, suitably, reliably, efficiently, enhancedly, and/or optimally) can enhance management of DRX associated with devices (e.g., device 110 and/or device 112) to achieve desirable communication performance and power savings, in accordance with the defined DRX management criteria. In some embodiments, the DRX manager component 114 can be part of the RAN 106 (as depicted), such as described herein. In certain other embodiments, the DRX manager component 114 can be a standalone component or part of another component, such as a controller (e.g., a RAN intelligent controller (RIC) or other type of controller), associated with the RAN(s) 106), and/or can be located or situated elsewhere in or associated with the communication network 102, wherein the DRX manager component 114 can be associated with (e.g., communicatively connected to) the RAN 106.

The DRX manager component 114 can employ MAC CE items (e.g., MAC CE values) and/or DCI items (e.g., DCI values), in addition to employing RRC signaling, to control and modify DRX parameters, including enabling or disabling DRX cycles, associated with devices (e.g., device 110 and/or device 112). The DRX manager component 114, by employing MAC CE items and DCI items to modify the DRX parameters associated with devices, can more quickly modify the DRX parameters than if RRC signaling had been utilized to modify the DRX parameters. In some embodiments, the DRX manager component 114 can utilize DCI signaling as a faster mechanism (e.g., a faster mechanism than RRC signaling) to enable or disable DRX cycles (e.g., short DRX cycles or long DRX cycles). For instance, the DRX manager component 114 can utilize a desired number of bits (e.g., one bit) in the DCI to control enabling and disabling of the DRX cycles associated with a device (e.g., device 110).

As a non-limiting example, if a long DRX cycle and a short DRX cycle are configured for the device 110, and the DRX manager component 114 determines, based at least in part on a data arrival pattern (e.g., a data traffic arrival pattern) of data traffic (e.g., video data traffic) and a PDB budget associated with the device 110, that the amount of power used by the device 110 can be reduced, while satisfying the PDB, if the length of the long DRX cycle is increased and the short DRX cycle is disabled, the DRX manager component 114 can utilize a first MAC CE value to modify a long DRX parameter to increase the length of the long DRX cycle, and can utilize a second MAC CE value or a DCI value to disable the short DRX cycle. For instance, the DRX manager component 114 can communicate the first MAC CE value and/or the second MAC CE value, as part of a data packet, comprising a MAC CE header section, and/or the DCI value, as part of DCI, to the device 110 to facilitate desirably (e.g., quickly, efficiently, and/or optimally) controlling the DRX parameters to modify the long DRX cycle and disable the short DRX cycle. The device 110, employing a DRX configuration component 116, can modify (e.g., reconfigure) the long DRX cycle to increase the length of the long DRX cycle to a modified long DRX cycle based at least in part on the first MAC CE value, and can disable the short DRX cycle based at least in part on the second MAC CE value or the DCI value, wherein the first MAC CE value can correspond to the modified long DRX cycle, and wherein the second MAC CE value or the DCI value can correspond to a disable value for disabling the short DRX cycle.

As another non-limiting example, if a long DRX cycle is configured for the device 110, a short DRX cycle is disabled, and there is a relatively short DRX inactivity timer set, and the DRX manager component 114 determines, based at least in part on a data arrival pattern (e.g., a data traffic arrival pattern) of data traffic (e.g., video data traffic) and a PDB budget associated with the device 110, that the PDB is not being satisfied, and/or the amount of power used by the device 110 can be reduced while satisfying the PDB, if the enabling the short DRX cycle or increasing the DRX inactivity timer, the DRX manager component 114 can utilize a first MAC CE value to modify a DRX inactivity timer parameter to increase the DRX inactivity timer, and can utilize a second MAC CE value or a DCI value to enable the short DRX cycle.

For instance, the DRX manager component 114 can communicate the first MAC CE value and/or the second MAC CE value, as part of a MAC CE header section of a data packet, and/or the DCI value, as part of DCI, to the device 110 to facilitate desirably (e.g., quickly, efficiently, and/or optimally) controlling the DRX parameters to modify the DRX inactivity timer to increase the timer or enable the short DRX cycle. The device 110, employing the DRX configuration component 116, can modify the DRX inactivity timer to increase the DRX inactivity timer to a modified DRX inactivity timer based at least in part on the first MAC CE value, or can enable the short DRX cycle based at least in part on the second MAC CE value or the DCI value, wherein the first MAC CE value can correspond to the modified DRX inactivity timer, and wherein the second MAC CE value or the DCI value can correspond to an enable value for enabling the short DRX cycle. These two non-limiting examples are but a few of numerous examples of modifications to DRX parameters that the DRX manager component 114 can perform, utilizing MAC CE items and/or DCI items, including such other examples of DRX management and modification as described herein.

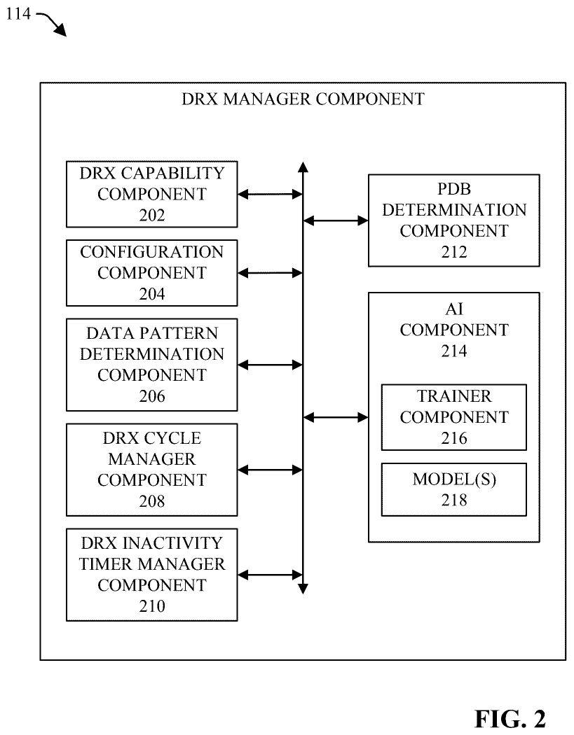

Referring to FIG. 2 (along with FIG. 1), FIG. 2 depicts a block diagram of a non-limiting example DRX manager component 114 that can desirably (e.g., automatically, dynamically, suitably, reliably, efficiently, enhancedly, and/or optimally) manage DRX associated with devices to achieve desirable communication performance and power savings, in accordance with various aspects and embodiments of the disclosed subject matter. In some embodiments, the DRX manager component 114 can comprise a DRX capability component 202 that can determine whether a device, such as the device 110, is configurable to employ short DRX cycles and has the capability to dynamically modify DRX parameters, including enabling and disabling of DRX cycles (e.g., short DRX cycles), using MAC CE items and/or DCI items. For instance, the DRX capability component 202 can communicate a device capability query to the device 110 to query the device 110 regarding whether the device 110 is configurable to employ short DRX cycles and has the capability to dynamically modify DRX parameters, including enabling and disabling of DRX cycles, using MAC CE items and/or DCI items.

In response to the query, the device 110 (e.g., the DRX configuration component 116 of the device 110) can communicate, to the DRX manager component 114 of or associated with the RAN 106, a message that can comprise device capability information that can indicate whether the device 110 is configurable to employ short DRX cycles and has the capability to dynamically modify DRX parameters, including enabling and disabling of DRX cycles, using MAC CE items and/or DCI items. In some embodiments, the message can comprise an information element (IE) that can comprise the device capability information for the device 110 or can otherwise indicate whether the device 110 is configurable to employ short DRX cycles and has the capability to dynamically modify DRX parameters, including enabling and disabling of DRX cycles, using MAC CE items and/or DCI items. For example, the message and associated IE can be structured as follows (e.g., if the device 110 can support accepting MAC CEs and a DCI bit field to reconfigure DRX cycles):

UE-NR-Capability
+ UE-NR-CapabilityAddXDD-Mode
+ + MAC-ParametersXDD-Diff ::= SEQUENCE {
...
dynamic-Drx ENUMERATED {supported} OPTIONAL,
...
}.

It is to be appreciated and understood that this is merely one non-limiting example message and associated IE that the device 110 can utilize to indicate its device capability with regard to DRX, and, in other embodiments, other types of messages and IEs can be employed by the devices (e.g., device 110) to indicate their device capabilities with regard to DRX.

The DRX manager component 114 can receive the message and associated IE from the device 110. If the message and associated IE indicate that the device 110 does not support short DRX cycles or have the capability to dynamically modify DRX parameters using MAC CE items and/or DCI items, based at least in part on the results of analyzing the message and associated IE, the DRX capability component 202 can determine that such features are not supported by the device 110, and the DRX manager component 114 can interact with the device 110 without employing such features. If, instead, the message and associated IE indicate that the device 110 does support short DRX cycles and has the capability to dynamically modify DRX parameters using MAC CE items and/or DCI items, based at least in part on the results of analyzing the message and associated IE, the DRX capability component 202 can determine that such features are supported by the device 110, and the DRX manager component 114 can interact with the device 110 to utilize such features, as desired (e.g., as appropriate or suitable), in accordance with the defined DRX management criteria. In some embodiments, if such features are supported by the device 110, the DRX capability component 202 can configure the base station 108 to have the base station 108 be able to interact with the device 110 using such features, in accordance with the defined DRX management criteria.

If the device 110 does support such features (e.g., dynamic DRX features, short DRX cycles), the DRX manager component 114 can employ a configuration component 204 that can utilize RRC signaling to configure or facilitate configuring the device 110 with regard to DRX (e.g., long DRX cycle parameters, including start offset and long DRX cycle duration; short DRX cycle parameters, including enabling or disabling of the short DRX cycle, short DRX cycle duration, and/or short DRX cycle timer parameter; DRX inactivity timer parameters; and/or another DRX parameter) and/or other features or functions. For instance, the configuration component 204 can communicate the RRC signal, comprising the configuration information relating to the DRX parameters and/or other parameters, to the device 110. To facilitate completing the handshake between the base station 108 and the device 110 with regard to the dynamic DRX features and short DRX cycle features, the RRC signal also can comprise configuration information that can indicate that the dynamic DRX features and short DRX cycle features can be utilized during the communication session between the device 110 and the base station 108. In some embodiments, the configuration component 204 can generate, and communicate to the device 110, the RRC signal (e.g., RRC configuration or reconfiguration signal) and/or an associated IE that can be in the following non-limiting example format or structure:
RRCReconfiguration-IEs::=
{
. . .
   nonCriticalExtension RRCReconfiguration-vXX-IEs
}
RRCReconfiguration-vXX-IEs:=
{
   dynamicDRX ENUMERATED {true}--OPTIONAL
}.

It is to be appreciated and understood that this is merely one non-limiting example message and associated IE that the configuration component 204 can utilize to indicate that the dynamic DRX features and short DRX cycle features can be utilized by the base station 108 and device 110 during the communication session, and, in other embodiments, other types of messages and IEs can be employed by the configuration component 204 to indicate that the dynamic DRX features and short DRX cycle features can be utilized by the base station 108 and the device 110 during the communication session.

The device 110 (e.g., the DRX configuration component 116 of the device 110) can configure the device 110 for DRX and/or other features or functions, including dynamic DRX features and short DRX cycle features, based at least in part on the configuration information contained in the RRC signal. For instance, based at least in part on the results of analyzing the configuration information, the DRX configuration component 116 can set the duration of the long DRX cycle, enable or disable the short DRX cycle, set the duration of the short DRX cycle if the short DRX cycle is enabled, set the short DRX cycle timer if the short DRX cycle is enabled, set the amount of time for the DRX inactivity timer, and/or set other features or functions, in accordance with the configuration information. After the configuration of the device 110 has been successfully completed, the DRX configuration component 116 can communicate, to the base station 108, a response message that can indicate that the configuration (e.g., DRX configuration and/or other configuration) of the device 110 has been successfully completed.

In some embodiments, the DRX manager component 114 can comprise a data pattern determination component 206 (which also can be referred to as, or can comprise, a data pattern analyzer component or data pattern analyzer) that can monitor and analyze information relating to data traffic arriving at devices, such as the device 110 and/or device 112, for example. Based at least in part on the results of analyzing the information relating to the data traffic arriving at the devices, the data pattern determination component 206 can determine respective data arrival patterns (e.g., respective data traffic arrival patterns) of respective data traffic arriving at the respective devices. For instance, based at least in part on the results of analyzing the information relating to the data traffic arriving at the device 110, the data pattern determination component 206 can determine the data arrival pattern (e.g., data traffic arrival pattern) of the data traffic, including determining (e.g., identifying or detecting) any change in the data arrival pattern, of the data traffic arriving at the device 110, such as described herein.

In some embodiments, the DRX manager component 114 can comprise a DRX cycle manager component 208 that can manage (e.g., automatically or dynamically control, set, reconfigure, adjust, or modify) parameters of DRX cycles associated with devices (e.g., device 110 and/or device 112) utilizing MAC CE and/or DCI. For instance, the DRX cycle manager component 208, employing MAC CE and/or DCI (e.g., MAC CE values and/or DCI values), can manage parameters of DRX cycles associated with the device 110 based at least in part on the data arrival pattern, the PDB (e.g., remaining PDB), and/or other characteristics or factors associated with the device 110, in accordance with the defined DRX management criteria, such as described herein. The parameters of the DRX cycles can comprise, for example, parameters of the long DRX cycle, including duration of the long DRX cycle, start offset of the long DRX cycle, and/or other parameters or functions of the long DRX cycle; and parameters of the short DRX cycle, including enabling or disabling of the short DRX cycle, the duration of the short DRX cycle if the short DRX cycle is enabled, the short DRX cycle timer if the short DRX cycle is enabled, and/or other parameters or functions of the short DRX cycle.

In certain embodiments, the DRX manager component 114 can comprise a DRX inactivity timer manager component 210 that can manage (e.g., automatically or dynamically control, set, reconfigure, adjust, or modify), utilizing MAC CE (e.g., MAC CE values), the amount of time for the DRX inactivity timer associated with DRX cycles associated with the device (e.g., device 110) for a communication session with the base station 108, and/or manage other DRX inactivity timer features or functions associated with the DRX cycles, such as described herein. For instance, the DRX inactivity timer manager component 210, employing MAC CE (e.g., MAC CE values), can manage the amount of time for the DRX inactivity timer, and/or other DRX inactivity timer features or functions, associated with the DRX cycles associated with the device 110 for the communication session with the base station 108, based at least in part on the data arrival pattern, the PDB (e.g., remaining PDB), and/or other characteristics or factors associated with the device 110, in accordance with the defined DRX management criteria, such as described herein.

In some embodiments, the DRX manager component 114 can comprise a PDB determination component 212 that can determine (e.g., identify or calculate) a PDB and/or a remaining PDB associated with data traffic associated with a device (e.g., device 110). For instance, the PDB determination component 212 can determine a PDB associated with (e.g., applicable to) data traffic associated with a device based at least in part on characteristics associated with the data traffic. The PDB determination component 212 can determine a remaining PDB based at least in part on the PDB and a group of network-related delay values or factors (e.g., core network (CN) PDB value, central unit (CU)-user plane (UP) delay value, downlink data delivery status (DDDS) delay value, distributed unit (DU) delay value, over the air (OTA) delay value, and/or another delay value) associated with the data traffic, such as described herein. The remaining PDB can be an amount of PDB associated with the data traffic that can remain after taking into account (e.g., after subtracting from the PDB) the respective amounts of delay associated with the respective delay values or factors of the group of delay values or factors.

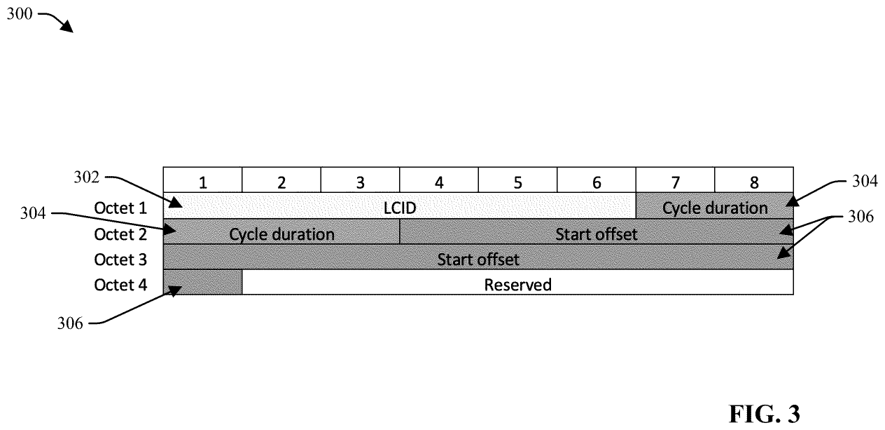

Referring to FIG. 3 (along with FIGS. 1 and 2), FIG. 3 illustrates a block diagram of a non-limiting example enhanced MAC CE 300 that can be utilized to manage (e.g., control, set, modify, reconfigure, or adjust) parameters associated with a long DRX cycle, in accordance with various aspects and embodiments of the disclosed subject matter. The example MAC CE 300 (e.g., long DRX cycle modification CE) can comprise various fields, comprising a logical channel identifier (LCID) field 302, a cycle duration field 304, a start offset field 306, and/or another desired field.

The LCID field 302 can comprise an LCID value that can indicate or represent a particular logical channel, of a group of logical channels, that is associated with the long DRX cycle and/or device 110. The LCID field 302 can comprise a desired number of bits (e.g., 6 bits, or another desired number of bits less or greater than 6 bits). The cycle duration field 304 can comprise cycle duration value that can indicate or represent a particular duration of the long DRX cycle. The cycle duration field 304 can comprise a desired number of bits (e.g., 5 bits, or another desired number of bits less or greater than 5 bits). The start offset field 306 can comprise start offset value that can indicate or represent a particular start offset of the long DRX cycle. The start offset field 306 can comprise a desired number of bits (e.g., 14 bits, or another desired number of bits less or greater than 14 bits).

In some embodiments, to facilitate managing the start offset and cycle duration of the long DRX cycle, the DRX cycle manager component 208 can select a desired (e.g., suitable, applicable, or optimal) start offset and associated start offset value for the start offset field 306, and a desired cycle duration for the cycle duration field 304, using an example IE, such as follows:

drx-LongCycleStartOffset CHOICE {
ms10 INTEGER(0..9),
ms20 INTEGER(0..19),
ms32 INTEGER(0..31),
ms40 INTEGER(0..39),
ms60 INTEGER(0..59),
ms64 INTEGER(0..63),
ms70 INTEGER(0..69),
ms80 INTEGER(0..79),
ms128 INTEGER(0..127),
ms160 INTEGER(0..159),
ms256 INTEGER(0..255),
ms320 INTEGER(0..319),
ms512 INTEGER(0..511),
ms640 INTEGER(0..639),
ms1024 INTEGER(0..1023),
ms1280 INTEGER(0..1279),
ms2048 INTEGER(0..2047),
ms2560 INTEGER(0..2559),
ms5120 INTEGER(0..5119),
ms10240 INTEGER(0..10239)}.

With regard to the start offset, the start offset field 306 can contain an integer value ranging from 0 to 10239 when the start offset field 306 comprises 14 bits. The DRX cycle manager component 208 can select the desired start offset value based at least in part on selection of an integer value that corresponds to (e.g., represents, is mapped to, or is associated with) the desired start offset, wherein the DRX cycle manager component 208 can insert the integer value into the start offset field 306.

To facilitate managing the cycle duration of the long DRX cycle, using the above example IE, the DRX cycle manager component 208 also can select a desired (e.g., suitable, applicable, or optimal) cycle duration value for the cycle duration field 304, wherein the cycle duration value can correspond to (e.g., can represent, be mapped to, or be associated with) the desired cycle duration for the long DRX cycle (e.g., a desired cycle duration that can facilitate satisfying the PDB). In some embodiments, to facilitate managing the cycle duration of the long DRX cycle, the DRX cycle manager component 208 can select the desired cycle duration and associated cycle duration value for the cycle duration field 304 using the above example IE, in accordance with the following non-limiting example TABLE 1 comprising ms values associated with (e.g., corresponding to, mapped to, linked to, or represented by) 5-bit cycle duration values, as follows:

TABLE 1

| | |
|---|---|
| ms10 | 00000 |
| ms20 | 00001 |
| ms32 | 00010 |
| ms40 | 00011 |
| ms60 | 00100 |
| ms64 | 00101 |
| ms70 | 00110 |
| ms80 | 00111 |
| ms128 | 01000 |
| ms160 | 01001 |
| ms256 | 01010 |
| ms320 | 01011 |
| ms512 | 01100 |
| ms640 | 01101 |
| ms1024 | 01110 |
| ms1280 | 01111 |
| ms2048 | 10000 |
| ms2560 | 10001 |
| ms5120 | 10010 |
| ms10240 | 10011 |

With regard to the ms values, ms 10 can represent 10 ms, ms20 can represent 20 ms, ms 32 can represent 32 ms, and so on, up through ms 10240 that can represent 10,240 ms. The DRX cycle manager component 208 can insert the desired cycle duration value into the cycle duration field 304 to facilitate setting or modifying the cycle duration of the long DRX cycle. It is to be appreciated and understood that this is merely one non-limiting example IE and set of cycle duration values (e.g., mapping of ms values to cycle duration values) that the DRX cycle manager component 208 can utilize to facilitate managing the cycle duration of the long DRX cycle, and, in other embodiments, other types IEs and sets of cycle duration values can be employed by the DRX cycle manager component 208 to facilitate managing the cycle duration of the long DRX cycle.

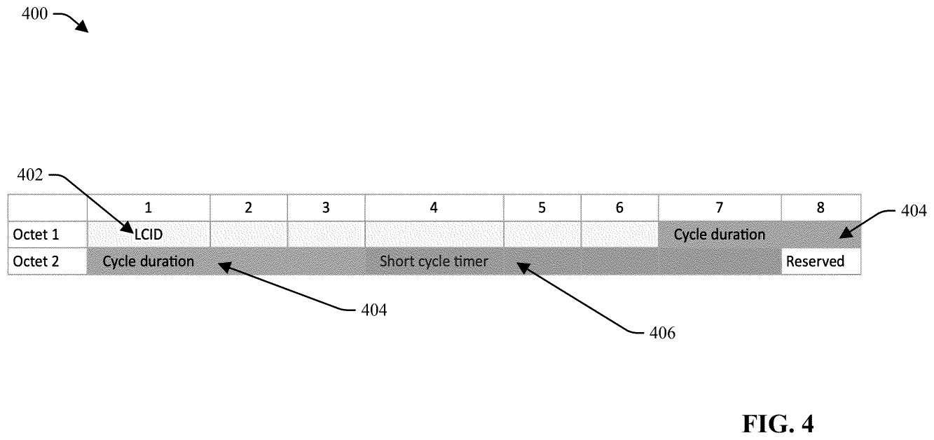

Turning to FIG. 4 (along with FIGS. 1 and 2), FIG. 4 depicts a block diagram of a non-limiting example enhanced MAC CE 400 that can be utilized to manage (e.g., control, set, modify, reconfigure, or adjust) parameters associated with a short DRX cycle, in accordance with various aspects and embodiments of the disclosed subject matter. The example MAC CE 400 (e.g., short DRX cycle modification CE) can comprise various fields, comprising an LCID field 402, a cycle duration field 404, a short DRX cycle timer field 406, and/or another desired field.

The LCID field 402 can comprise an LCID value that can indicate or represent a particular logical channel, of the group of logical channels, that is associated with the short DRX cycle and/or device 110. The LCID field 402 can comprise a desired number of bits (e.g., 6 bits, or another desired number of bits less or greater than 6 bits). The cycle duration field 404 can comprise cycle duration value that can indicate or represent a particular duration of the short DRX cycle. The cycle duration field 404 can comprise a desired number of bits (e.g., 5 bits, or another desired number of bits less or greater than 5 bits). The short DRX cycle timer field 406 can comprise short cycle timer value that can indicate or represent a particular amount of time of the short cycle timer of the short DRX cycle. The short DRX cycle timer field 406 can comprise a desired number of bits (e.g., 4 bits, or another desired number of bits less or greater than 4 bits).

In some embodiments, to facilitate managing the short DRX cycle, the DRX cycle manager component 208 can select a desired (e.g., suitable, applicable, or optimal) cycle duration and associated cycle duration value for the cycle duration field 404, and a desired short DRX cycle timer and associated short DRX cycle timer value for the short DRX cycle timer field 406, using an example IE, such as follows:
drx-ShortCycle ENUMERATED {ms2, ms3, ms4, ms5, ms6, ms7, ms8, ms10, ms14, ms16, ms20, ms30, ms32, ms35, ms40, ms64, ms80, ms128, ms160, ms256, ms320, ms512, ms640, spare9, spare8, spare7, spare6, spare5, spare4, spare3, spare2, spare1},
drx-ShortCycleTimer INTEGER (1 . . . 16)
wherein, for example, as shown in non-limiting TABLE 2, the ms values can be associated with (e.g., can correspond to, can be mapped to, or can represent) 5-bit cycle duration values as follows:

TABLE 2

| | |
|---|---|
| ms2 | 00000 |
| ms3 | 00001 |
| ms4 | 00010 |
| ms5 | 00011 |
| ms6 | 00100 |
| ms7 | 00101 |
| ms8 | 00110 |
| ms10 | 00111 |
| ms14 | 01000 |
| ms16 | 01001 |
| ms20 | 01010 |
| ms30 | 01011 |
| ms32 | 01100 |
| ms35 | 01101 |
| ms40 | 01110 |
| ms64 | 01111 |
| ms80 | 10000 |
| ms128 | 10001 |
| ms160 | 10010 |
| ms256 | 10011 |
| ms320 | 10100 |
| ms512 | 10101 |
| ms640 | 10110 |

The DRX cycle manager component 208 can insert the desired cycle duration value into the cycle duration field 404 to facilitate setting or modifying the cycle duration for the short DRX cycle, and the desired short DRX cycle timer value (e.g., a value that can range from 1 to 16) into the short DRX cycle timer field 406 to facilitate setting or adjusting the length of time for the short DRX cycle timer. It is to be appreciated and understood that this is merely one non-limiting example IE and set of cycle duration values (e.g., mapping of ms values to cycle duration values) that the DRX cycle manager component 208 can utilize to facilitate managing the cycle duration of the short DRX cycle, and, in other embodiments, other types IEs and sets of cycle duration values can be employed by the DRX cycle manager component 208 to facilitate managing the cycle duration of the short DRX cycle.

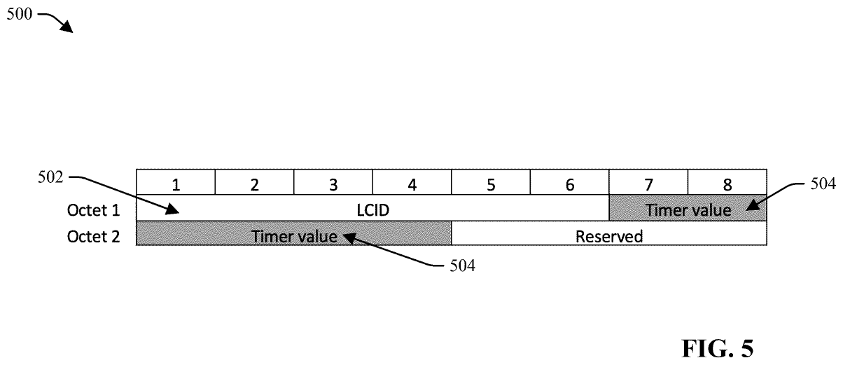

Referring to FIG. 5 (along with FIGS. 1 and 2), FIG. 5 illustrates a block diagram of a non-limiting example enhanced MAC CE 500 that can be utilized to manage (e.g., control, set, modify, reconfigure, or adjust) parameters associated with a DRX inactivity timer, in accordance with various aspects and embodiments of the disclosed subject matter. The example MAC CE 500 (e.g., DRX inactivity timer CE) can comprise various fields, comprising an LCID field 502, a timer field 504, and/or another desired field.

The LCID field 502 can comprise an LCID value that can indicate or represent a particular logical channel, of the group of logical channels, that is associated with the DRX and/or device 110. The LCID field 502 can comprise a desired number of bits (e.g., 6 bits, or another desired number of bits less or greater than 6 bits). The timer field 504 can comprise an inactivity timer value that can indicate or represent a particular time length of the inactivity timer associated with the DRX. The timer field 504 can comprise a desired number of bits (e.g., 6 bits, or another desired number of bits less or greater than 6 bits).

In some embodiments, to facilitate managing the DRX inactivity timer, the DRX inactivity timer manager component 210 can select a desired (e.g., suitable, applicable, or optimal) DRX inactivity timer and associated DRX inactivity timer value for the timer field 504 using an example IE, such as follows:
drx-InactivityTimer ENUMERATED {ms0, ms1, ms2, ms3, ms4, ms5, ms6, ms8, ms10, ms20, ms30, ms40, ms50, ms60, ms80, ms100, ms200, ms300, ms500, ms750, ms 1280, ms1920, ms2560, spare9, spare8, spare7, spare6, spare5, spare4, spare3, spare2, spare1}
wherein, for example, as shown in non-limiting TABLE 3, the ms values can be associated with (e.g., can correspond to, can be mapped to, or can represent) 6-bit inactivity timer values as follows:

TABLE 3

| | |
|---|---|
| ms0 | 000000 |
| ms1 | 000001 |
| ms2 | 000010 |
| ms3 | 000011 |
| ms4 | 000100 |
| ms5 | 000101 |
| ms6 | 000110 |
| ms8 | 000111 |
| ms10 | 001000 |
| ms20 | 001001 |
| ms30 | 001010 |
| ms40 | 001011 |
| ms50 | 001100 |
| ms60 | 001101 |
| ms80 | 001110 |
| ms100 | 001111 |
| ms200 | 010000 |
| ms300 | 010001 |
| ms500 | 010010 |
| ms750 | 010011 |
| ms1280 | 010100 |
| ms1920 | 010101 |
| ms2560 | 010110 |

The DRX inactivity timer manager component 210 can insert the desired DRX inactivity timer value into the timer field 504 to facilitate setting or modifying the DRX inactivity timer. It is to be appreciated and understood that this is merely one non-limiting example IE and set of inactivity timer values (e.g., mapping of ms values to inactivity timer values) that the DRX inactivity timer manager component 210 can utilize to facilitate managing the inactivity timer associated with the DRX, and, in other embodiments, other types IEs and sets of inactivity timer values can be employed by the DRX inactivity timer manager component 210 to facilitate managing the inactivity timer associated with the DRX.

It is to be appreciated and understood that the respective IEs disclosed herein with regard to the long DRX cycle and the short DRX cycle are non-limiting example IEs, and in accordance with various other embodiments of the disclosed subject matter, the DRX manager component 114 can employ different IEs with regard to the long DRX cycle and/or the short DRX cycle than those non-limiting example IEs described herein. It also is to be appreciated and understood that the respective ms values and respective associated binary values (e.g., cycle duration values and inactivity timer values) presented in TABLE 1, TABLE 2, and TABLE 3 are non-limiting example values, and, in accordance with various other embodiments of the disclosed subject matter, the DRX manager component 114 can employ different ms values and associated values than those presented in TABLE 1, TABLE 2, and TABLE 3.

As disclosed, in some embodiments, the DRX cycle manager component 208 can employ DCI to manage (e.g., control, modify, enable, or disable) the short DRX cycle associated with the device 110. In certain embodiments, if DCI is utilized to enable or disable a DRX cycle (e.g., the short DRX cycle) associated with the device 110, the DRX manager component 114 can set the bit in the DRX bit field to a first value (e.g., 1, or another desired alternate first value) to enable or make active the DRX cycle or a second value (e.g., 0, or another desired alternate second value) to disable or make inactive the DRX cycle (e.g., from the current long DRX cycle).

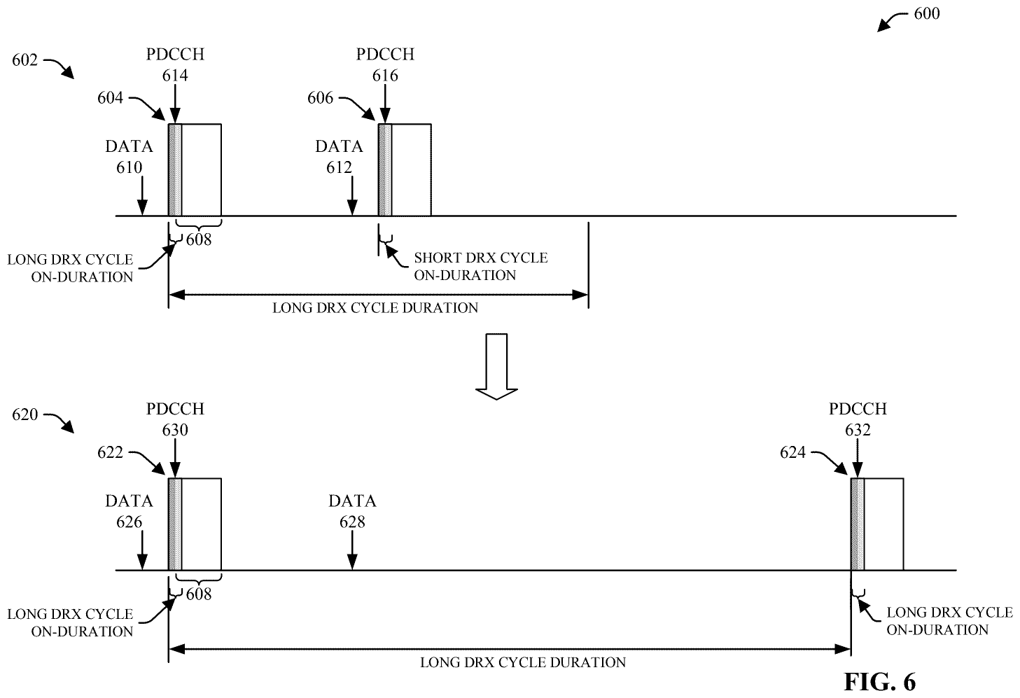

To further illustrate various aspects of the disclosed subject matter, a few example scenarios can be presented. Referring to FIG. 6 (along with FIGS. 1-5), FIG. 6 illustrates a diagram of a non-limiting example scenario 600 relating to communication of data traffic, comprising video (e.g., non-conversational and/or buffered streaming video), to the device 110 using a configured DRX pattern where modification of DRX pattern, using MAC CE and/or DCI, can satisfy the PDB associated with the data traffic and reduce power usage by the device 110, in accordance with various aspects and embodiments of the disclosed subject matter. In the example scenario 600, the video data traffic can be carried by a 5QI flow where the 5QI value can be, for example, 4, 6, 8, or 9, wherein the video data traffic can have a PDB, for example, of 300 ms (e.g., with a net end-to-end delay of 280 ms).

The example scenario 600 can comprise the configured (e.g., RRC-configured) DRX pattern 602 that can comprise a long DRX cycle that can have a long DRX cycle duration of 160 ms, with a long DRX cycle 604 (e.g., an on-period long DRX cycle) at a particular time that can be at the beginning of the long DRX cycle duration (e.g., the long DRX cycle period) of the long DRX cycle. The long DRX cycle 604 can have an on-duration of, for example, 5 ms, wherein the device 110 can have its receiver component on (e.g., in the on state) to monitor for PDCCH during the on-duration of the long DRX cycle 604. The configured DRX pattern 602 also can comprise a short DRX cycle 606 (e.g., an on-period short DRX cycle) that can occur in the middle (e.g., long DRX cycle duration/2=80 ms) of the long DRX cycle duration and in between two consecutive long DRX cycles (e.g., long DRX cycle 604 and the next long DRX cycle). The short DRX cycle 606 can have an on-duration of, for example, 5 ms, wherein the device 110 can have its receiver component in the on state to monitor for PDCCH during the on-duration of the short DRX cycle 606. The configured DRX pattern 602 also can comprise a DRX inactivity timer that can have a DRX inactivity timer duration of, for example, 20 ms, as indicated at reference numeral 608.

In the example scenario 600, with regard to the example data traffic arrival pattern comprising first data traffic 610 and second data traffic 612, the first data traffic 610 can be at the base station 108 at a first time prior to the on-duration of the long DRX cycle 604, and the base station 108 can buffer the first data traffic 610 in a buffer component of the base station 108, and can schedule communication of the first data traffic 610 to the device 110 to occur during the on-duration of the long DRX cycle 604 when the device 110 can be monitoring for PDCCH (e.g., first PDCCH 614); and the second data traffic 612 can be at the base station 108 at a second time prior to the on-duration of the short DRX cycle 606, and the base station 108 can buffer the second data traffic 612 in the buffer component, and can schedule communication of the second data traffic 612 to the device 110 to occur during the on-duration of the short DRX cycle 606 when the device 110 can be monitoring for PDCCH (e.g., second PDCCH 616).

The data pattern determination component 206 can analyze the data traffic, and can determine the data traffic arrival pattern based at least in part on the results of the analysis of the data traffic, including determining that the first data traffic 610 can arrive and be ready for communication to the device 110 at the first time prior to the long DRX cycle 604 and the second data traffic 612 can arrive and be ready for communication to the device 110 at the second time prior to the short DRX cycle 606.

The DRX cycle manager component 208 can analyze the data traffic arrival pattern, the PDB associated with the data traffic, the long DRX cycle 604, and the short DRX cycle 606. Based at least in part on the results of analyzing the data traffic arrival pattern, PDB, long DRX cycle 604, and short DRX cycle 606, the DRX cycle manager component 208 can determine that the configured DRX pattern 602 may not desirably satisfy the data traffic carried by the 5QI flow where the 5QI value can be, for example, 4, 6, 8, or 9. For instance, based at least in part on the results of such analysis, the DRX cycle manager component 208 can determine that, since the PDB of the data traffic (e.g., video data traffic) can tolerate up to 280 ms of data packet delay, the long DRX cycle 604 can be modified (e.g., rescaled or adjusted) to have a longer long DRX cycle duration, such as 256 ms, and the short DRX cycle 606 can be disabled for future DRX cycles, which can enable the PDB associated with the data traffic to be satisfied (e.g., met) while also reducing the amount of power utilized by the device 110 because the device 110 will not have to wake up (e.g., power on) its receiver component to monitor for short DRX cycles if those short DRX cycles are disabled.

As disclosed, using RRC signaling to modify the long DRX cycle and disable the short DRX cycle can be undesirable, as RRC signaling can be inefficient, time consuming (e.g., can have undesirably high latency associated with reconfiguration of the DRX pattern), and expensive (e.g., can be expensive with regard to resources and power utilized with RRC signaling to reconfigure the DRX pattern and/or with regard to power utilized by the device 110 to unnecessarily have its receiver component in the on state (e.g., during on-duration of the short DRX cycle) to monitor for PDCCH). Further, faster modification of DRX patterns and DRX cycles can be desirable (e.g., wanted, necessary, suitable, or optimal), as data traffic arrival patterns often can change (e.g., shift) such that a DRX modification using RRC signaling may no longer even be useful by the time it is implemented.

In accordance with various embodiments, the DRX cycle manager component 208 desirably (e.g., automatically, dynamically, suitably, efficiently, enhancedly, or optimally) can utilize MAC CE (e.g., MAC CE values) and/or DCI (e.g., a DCI value of a DCI bit) to manage the DRX pattern to modify the configured DRX pattern to a modified DRX pattern 620 where the cycle duration of the long DRX cycle can be increased to a longer long DRX cycle duration (e.g., 256 ms) and the short DRX cycle 606 can be disabled for future DRX cycles. For instance, based at least in part on the results of analyzing the data traffic arrival pattern, PDB, long DRX cycle 604, and short DRX cycle 606, the DRX cycle manager component 208 can determine the modified DRX pattern 620 that can have such longer long DRX cycle duration (e.g., 256 ms) and can have no short DRX cycle. The modified DRX pattern 620 can have a first long DRX cycle 622 at a first long DRX cycle time and a second long DRX cycle 624 at a second long DRX cycle time, in accordance with the modified (e.g., longer) long DRX cycle duration (e.g., 256 ms), and can contain no short DRX cycle, which can be compatible with the data traffic arrival pattern and can satisfy the PDB associated with the data traffic.

To facilitate implementing the modified DRX pattern 620, the DRX cycle manager component 208 desirably (e.g., automatically, dynamically, suitably, efficiently, enhancedly, or optimally) can communicate a MAC CE, comprising a desired MAC CE value to modify the cycle duration (e.g., 160 ms) of the long DRX cycle to a modified cycle duration (e.g., 256 ms), and a desired MAC CE value or a DCI bit value to disable the short DRX cycle. For example, the DRX cycle manager component 208 can insert a particular value (e.g., 01010 associated with ms256) that can correspond to the modified cycle duration (e.g., 256 ms) into the cycle duration field (e.g., cycle duration field 304) of the MAC CE (e.g., MAC CE 300) for the long DRX cycle. The DRX cycle manager component 208 also can insert a certain value that can correspond to disabling the short DRX cycle into the MAC CE (e.g., MAC CE 400) for the short DRX cycle or can utilize a DCI bit value (e.g., 0), which can be a disable value, as part of the DCI, to facilitate disabling the short DRX cycle.

The DRX cycle manager component 208 can communicate, to the device 110, the MAC CE (e.g., associated with the long DRX cycle), comprising the particular value, for modifying the long DRX cycle, and the other MAC CE (e.g., associated with the short DRX cycle), comprising the certain (e.g., disable) value, or the DCI, comprising the disable value, for disabling the short DRX cycle, in accordance with the modified DRX pattern 620. The device 110 can receive the MAC CE(s) and/or the DCI from the base station 108. The device 110, employing the DRX configuration component 116, can modify (e.g., reconfigure) the long DRX cycle to have the longer long DRX cycle duration (e.g., 256 ms) and can disable the short DRX cycle, based at least in part on the particular value (e.g., to increase the long DRX cycle duration), and the certain (e.g., disable) value contained in the MAC CE(s) or the disable value contained in the DCI received from the DRX cycle manager component 208 (e.g., via the base station 108).

Subsequently, in accordance with the data traffic arrival pattern, third data traffic 626 can arrive (e.g., can be received and buffered at the base station 108 and ready for communication to the device 110) at a third time prior to the first long DRX cycle 622, and fourth data traffic 628 can arrive at a fourth time prior to the second long DRX cycle 624. In accordance with the modified DRX pattern 620, when the base station 108 receives the third data traffic 626, the base station 108 can buffer the third data traffic 626 in the buffer component, and can schedule communication of the third data traffic 626 to the device 110 to occur during the on-duration of the first long DRX cycle 622 when the device 110 can be monitoring for PDCCH (e.g., third PDCCH 630). In accordance with such scheduling, the base station 108 can communicate the third data traffic 626 to the device 110 during the on-duration of the first long DRX cycle 622, and the device 110 can have its receiver component in the on state to monitor for the third PDCCH 630, and can receive the third data traffic 626 during that time. In accordance with the modified DRX pattern 620, when the base station 108 receives the fourth data traffic 628, the base station 108 can buffer the fourth data traffic 628 in the buffer component, and can schedule communication of the fourth data traffic 628 to the device 110 to occur during the on-duration of the second long DRX cycle 624 when the device 110 can be monitoring for PDCCH (e.g., fourth PDCCH 632). In accordance with such scheduling, the base station 108 can communicate the fourth data traffic 628 to the device 110 during the on-duration of the second long DRX cycle 624, and the device 110 can have its receiver component in the on state to monitor for the fourth PDCCH 632, and can receive the fourth data traffic 628 during that time.

The DRX manager component 114, by modifying the configured DRX pattern 602 to increase the cycle duration of the long DRX cycle and disable the short DRX cycle, can reduce the amount of power consumed by the device 110 while satisfying the PDB associated with the data traffic, enhance performance of the device 110, and enhance performance of the communication network 102. The DRX manager component 114 can continue to monitor the data traffic to facilitate determining whether the data traffic arrival pattern associated with the data traffic changes and/or determining whether to modify the modified DRX pattern 620, in accordance with the defined DRX management criteria.

With further regard to this example scenario, in other embodiments, as an alternative, instead of modifying the duration of the long DRX cycle from 160 ms to 256 ms and disabling the short DRX cycle, the DRX manager component 114 (e.g., employing the DRX cycle manager component 208) can determine that the short DRX cycle can be disabled, but the long DRX cycle duration can remain at 160 ms, since the PDB associated with the data traffic can still be satisfied and power consumption associated with the device 110 can still be reduced under this alternate modified DRX pattern (although the amount of power reduction may be less than when the long DRX cycle duration is modified from 160 ms to 256 ms and the short DRX cycle is disabled).

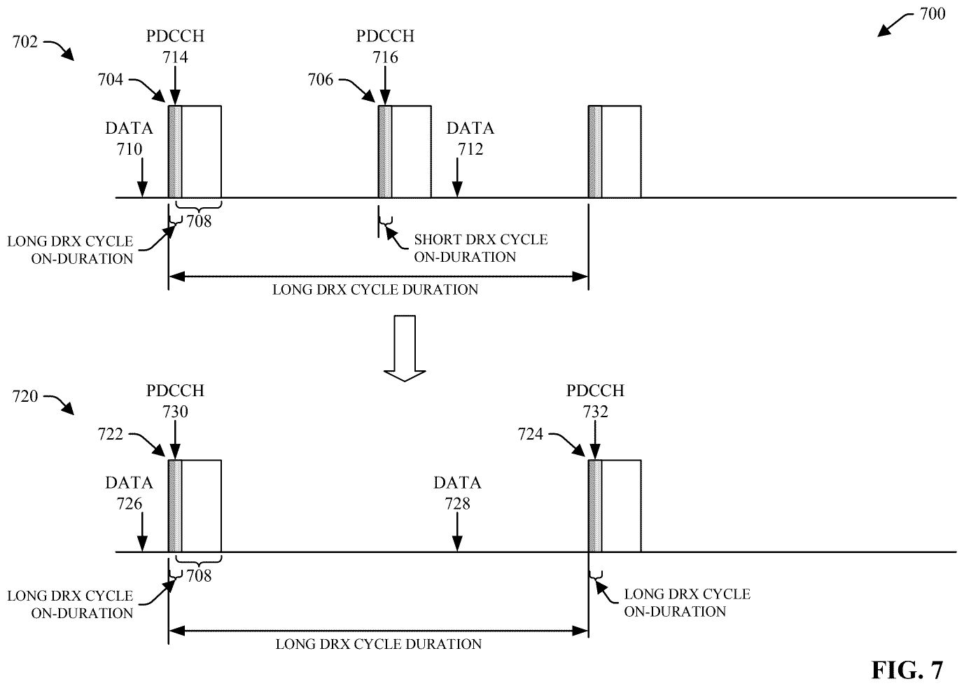

Turning to FIG. 7 (along with FIGS. 1-5), FIG. 7 depicts a diagram of a non-limiting example scenario 700 relating to communication of data traffic, comprising video (e.g., non-conversational and/or buffered streaming video), to the device 110 using a configured DRX pattern where modification of the configured DRX pattern, using MAC CE and/or DCI, to disable the short DRX cycle can satisfy the PDB associated with the data traffic and reduce power usage by the device 110, in accordance with various aspects and embodiments of the disclosed subject matter. In the example scenario 700, the video data traffic can be carried by a 5QI flow where the 5QI value can be, for example, 4, 6, 8, or 9, wherein the video data traffic can have a PDB, for example, of 300 ms (e.g., with a net end-to-end delay of 280 ms).

The example scenario 700 can comprise a configured (e.g., RRC-configured) DRX pattern 702 that can comprise a long DRX cycle that can have a long cycle duration of 160 ms, with a long DRX cycle 704 (e.g., an on-period long DRX cycle) at a particular time that can be at the beginning of the long DRX cycle duration (e.g., the long DRX cycle period) of the long DRX cycle. The long DRX cycle 704 can have an on-duration of, for example, 5 ms, wherein the device 110 can have its receiver component in the on state to monitor for PDCCH during the on-duration of the long DRX cycle 704. The configured DRX pattern 702 also can comprise a short DRX cycle 706 (e.g., an on-period short DRX cycle) that can occur in the middle (e.g., long DRX cycle duration/2=80 ms) of the long DRX cycle duration and in between two consecutive long DRX cycles (e.g., long DRX cycle 704 and the next long DRX cycle). The short DRX cycle 706 can have an on-duration of, for example, 5 ms, wherein the device 110 can have its receiver component in the on state to monitor for PDCCH during the on-duration of the short DRX cycle 706. The configured DRX pattern 702 also can comprise a DRX inactivity timer that can have a DRX inactivity timer duration of, for example, 20 ms, as indicated at reference numeral 708.

In the example scenario 700, with regard to the example data traffic arrival pattern comprising first data traffic 710 and second data traffic 712, the first data traffic 710 can be at the base station 108 at a first time prior to the on-duration of the long DRX cycle 704, wherein the base station 108 can buffer the first data traffic 710 in its buffer component, and can schedule communication of the first data traffic 710 to the device 110 to occur during the on-duration of the long DRX cycle 704 when the device 110 can be monitoring for PDCCH (e.g., first PDCCH 714); and the second data traffic 712 can be at the base station 108 at a second time after the on-duration of the short DRX cycle 706, wherein the base station 108 can buffer the second data traffic 712 in its buffer component. Since the second data traffic 712 arrives after the on-duration of the short DRX cycle 706, the second data traffic 712 can remain in the buffer component until the next long DRX cycle, which can occur 160 ms after the occurrence of the long DRX cycle 704. The base station 108 can schedule communication of the second data traffic 712 to the device 110 to occur during the on-duration of the next long DRX cycle when the device 110 can be monitoring for PDCCH (e.g., second PDCCH).

The data pattern determination component 206 can analyze the data traffic, and can determine the data traffic arrival pattern based at least in part on the results of the analysis of the data traffic, including determining that the first data traffic 710 can arrive and be ready for communication to the device 110 at the first time prior to the long DRX cycle 704 and the second data traffic 712 can arrive and be ready for communication to the device 110 at the second time after the short DRX cycle 706.

The DRX cycle manager component 208 can analyze the data traffic arrival pattern, the PDB associated with the data traffic, the long DRX cycle 704, and the short DRX cycle 706. Based at least in part on the results of analyzing the data traffic arrival pattern, PDB, long DRX cycle 704, and short DRX cycle 706, the DRX cycle manager component 208 can determine that the configured DRX pattern 702 may not desirably satisfy the data traffic carried by the 5QI flow where the 5QI value can be, for example, 4, 6, 8, or 9. For instance, based at least in part on the results of such analysis, the DRX cycle manager component 208 can determine that, since the PDB of the data traffic (e.g., video data traffic) can tolerate up to 280 ms of data packet delay, since the second data traffic 712 arrives after the short DRX cycle 706 has occurred and ended, and since the long cycle duration is 160 ms, the short DRX cycle 706 can be disabled for future DRX cycles, which can enable the PDB associated with the data traffic to still be satisfied (e.g., since the long cycle duration is 160 ms) while also reducing the amount of power utilized by the device 110 because the device 110 will not have to wake up (e.g., power on) its receiver component to monitor for short DRX cycles if those short DRX cycles are disabled. In some embodiments, based at least in part on the analysis results, the DRX cycle manager component 208 can determine that, since the PDB of the data traffic can tolerate up to 280 ms of data packet delay, the long DRX cycle 704 also can be modified (if desired) to have a longer long DRX cycle duration, such as 256 ms (e.g., same or similar to the example scenario 600).

As disclosed, using RRC signaling to disable the short DRX cycle and/or modifying the long DRX cycle duration can be undesirable (e.g., inefficient, time consuming (e.g., may take hundreds of milliseconds), and expensive). Further, faster modification of DRX patterns and DRX cycles can be desirable, as data traffic arrival patterns often can change such that a DRX modification using RRC signaling may no longer even be useful by the time it is implemented.

In accordance with various embodiments, the DRX cycle manager component 208 desirably can utilize a MAC CE (e.g., MAC CE value) and/or DCI (e.g., a DCI value of a DCI bit) to manage the DRX pattern to modify the configured DRX pattern 702 to a modified DRX pattern 720 where the short DRX cycle 706 can be disabled for future DRX cycles. Also, if it is desired modify the long DRX cycle duration to increase it to, for example, 256 ms, the DRX cycle manager component 208 desirably can utilize another MAC CE (e.g., another MAC CE value) to further modify the configured DRX pattern 702 to the modified DRX pattern 720. For instance, based at least in part on the results of analyzing the data traffic arrival pattern, PDB, long DRX cycle 704, and short DRX cycle 706, the DRX cycle manager component 208 can determine the modified DRX pattern 720 that can have no short DRX cycle and/or can have a lengthened long DRX cycle duration. The modified DRX pattern 720 can have a first long DRX cycle 722 at a first long DRX cycle time and a second long DRX cycle 724 at a second long DRX cycle time, in accordance with the long DRX cycle duration (e.g., 160 ms) or the increased long DRX cycle duration (e.g., 256 ms), and can contain no short DRX cycle, which can be compatible with the data traffic arrival pattern and can satisfy the PDB associated with the data traffic.

To facilitate implementing the modified DRX pattern 720, the DRX cycle manager component 208 desirably can communicate, to the device 110, a desired (e.g., suitable or corresponding) MAC CE value or a DCI bit value to disable the short DRX cycle, and/or another MAC CE value to increase the long DRX cycle duration. For example, the DRX cycle manager component 208 can insert a certain value that can correspond to disabling the short DRX cycle into the MAC CE (e.g., MAC CE 400) for the short DRX cycle or can utilize a DCI bit value (e.g., 0), which can be a disable value, as part of the DCI, to facilitate disabling the short DRX cycle, and/or can the DRX cycle manager component 208 can insert a particular value (e.g., 01010 associated with ms256) that can correspond to the modified (e.g., increased) cycle duration (e.g., 256 ms) into the cycle duration field (e.g., cycle duration field 304) of the MAC CE (e.g., MAC CE 300) for the long DRX cycle.

The DRX cycle manager component 208 can communicate, to the device 110, the MAC CE (e.g., associated with the short DRX cycle), comprising the certain (e.g., disable) value, or the DCI, comprising the disable value, for disabling the short DRX cycle, and/or the other MAC CE (e.g., to modify the long DRX cycle duration), in accordance with the modified DRX pattern 720. The device 110 can receive the MAC CE(s) or the DCI from the base station 108. The device 110, employing the DRX configuration component 116, can disable the short DRX cycle, based at least in part on the certain (e.g., disable) value contained in the MAC CE or the disable value contained in the DCI received from the DRX cycle manager component 208 (e.g., via the base station 108), and/or can modify (e.g., increase) the long DRX cycle duration, based at least in part on the other MAC CE value.

Subsequently, in accordance with the data traffic arrival pattern, third data traffic 726 can arrive (e.g., can be received and buffered at the base station 108 and ready for communication to the device 110) at a third time prior to the first long DRX cycle 722, and fourth data traffic 728 can arrive at a fourth time prior to the second long DRX cycle 724. In accordance with the modified DRX pattern 720, when the base station 108 receives the third data traffic 726, the base station 108 can buffer the third data traffic 726 in its buffer component, and can schedule communication of the third data traffic 726 to the device 110 to occur during the on-duration of the first long DRX cycle 722 when the device 110 can be monitoring for PDCCH (e.g., third PDCCH 730). In accordance with such scheduling, the base station 108 can communicate the third data traffic 726 to the device 110 during the on-duration of the first long DRX cycle 722, and the device 110 can have its receiver component in the on state to monitor for the third PDCCH 730, and can receive the third data traffic 726 during that time. In accordance with the modified DRX pattern 720, when the base station 108 receives the fourth data traffic 728, the base station 108 can buffer the fourth data traffic 728 in its buffer component, and can schedule communication of the fourth data traffic 728 to the device 110 to occur during the on-duration of the second long DRX cycle 724 when the device 110 can be monitoring for PDCCH (e.g., fourth PDCCH 732). In accordance with such scheduling, the base station 108 can communicate the fourth data traffic 728 to the device 110 during the on-duration of the second long DRX cycle 724, and the device 110 can have its receiver component in the on state to monitor for the fourth PDCCH 732, and can receive the fourth data traffic 728 during that time.

The DRX manager component 114, by modifying the configured DRX pattern 702 to disable the short DRX cycle and/or increase the cycle duration of the long DRX cycle, can reduce the amount of power consumed by the device 110 while satisfying the PDB associated with the data traffic, enhance performance of the device 110, and enhance performance of the communication network 102. The DRX manager component 114 can continue to monitor the data traffic to facilitate determining whether the data traffic arrival pattern associated with the data traffic changes and/or determining whether to modify the modified DRX pattern 720, in accordance with the defined DRX management criteria.

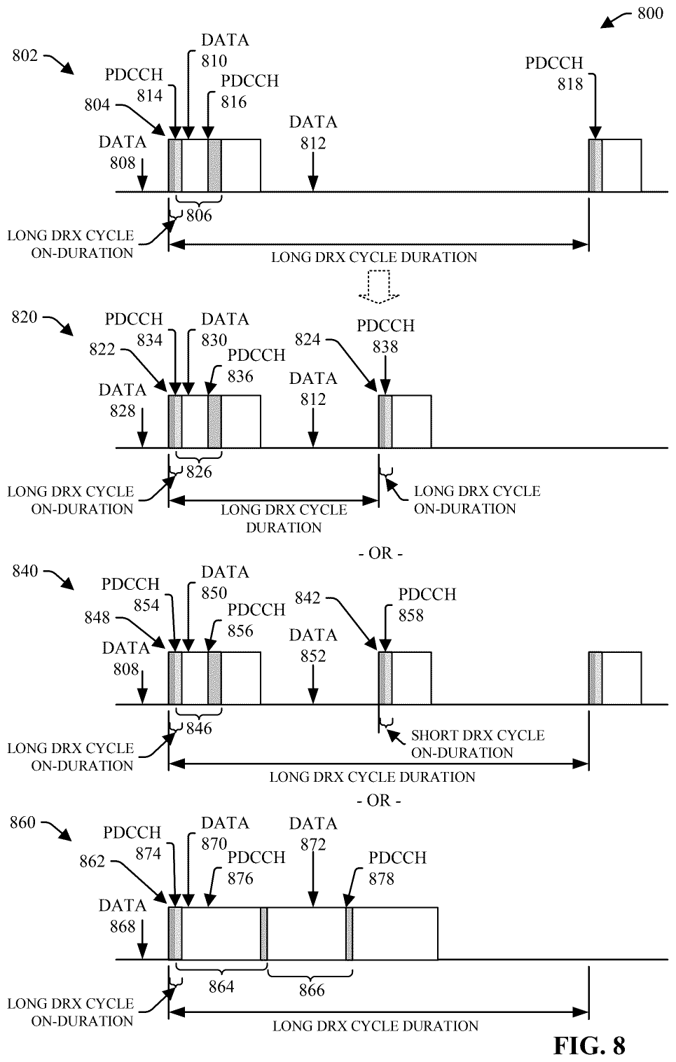

Referring to FIG. 8 (along with FIGS. 1-5), FIG. 8 illustrates a diagram of a non-limiting example scenario 800 relating to communication of data traffic, comprising voice data traffic (e.g., conversational voice data traffic), to the device 110 using a configured DRX pattern where modification of the configured DRX pattern, using MAC CE and/or DCI, to modify the long DRX cycle, enable the short DRX cycle, or modify the DRX inactivity timer can satisfy the PDB associated with the data traffic and reduce power usage by the device 110, in accordance with various aspects and embodiments of the disclosed subject matter. In the example scenario 800, the voice data traffic can be carried by a 5QI flow where the 5QI value can be, for example, 1 or 2, wherein the voice data traffic can have a PDB, for example, of 100 ms. It is noted that, while this example scenario 800 relates to voice data traffic, the DRX manager component 114 can employ a similar approach when the data traffic is, for example, live streaming of video.

The example scenario 800 can comprise a configured (e.g., RRC-configured) DRX pattern 802 that can comprise a long DRX cycle that can have a long cycle duration of 160 ms, with a long DRX cycle 804 (e.g., an on-period long DRX cycle) at a particular time that can be at the beginning of the long DRX cycle duration (e.g., the long DRX cycle period) of the long DRX cycle. The long DRX cycle 804 can have an on-duration of, for example, 5 ms, wherein the device 110 can have its receiver component in the on state to monitor for PDCCH during the on-duration of the long DRX cycle 804. The configured DRX pattern 802 can have no short DRX cycle configured. The configured DRX pattern 802 also can comprise a DRX inactivity timer that can have a DRX inactivity timer duration of, for example, 20 ms, as indicated at reference numeral 806.

In the example scenario 800, with regard to the example data traffic arrival pattern, comprising first data traffic 808, second data traffic 810, and third data traffic 812, the first data traffic 808 can be at the base station 108 at a first time prior to the on-duration of the long DRX cycle 804, wherein the base station 108 can buffer the first data traffic 808 in its buffer component, and can schedule communication of the first data traffic 808 to the device 110 to occur during the on-duration of the long DRX cycle 804 when the device 110 can be monitoring for PDCCH (e.g., first PDCCH 814); and the second data traffic 810 can be at the base station 108 at a second time after the long DRX cycle 804 but during the time period (e.g., duration) of the DRX inactivity timer, wherein the base station 108 can buffer the second data traffic 810 in its buffer component, and can schedule communication of the second data traffic 810 to the device 110 to occur while the device 110 is monitoring for PDCCH (e.g., second PDCCH 816) during the time period of the DRX inactivity timer. With further regard to the example data traffic arrival pattern, and with the data traffic arrival pattern being inconsistent or irregular, the third data traffic 812 can be at the base station 108 at a third time after the long DRX cycle 804 and after the DRX inactivity timer has expired. Since the third data traffic 812 arrives after the on-duration of the long DRX cycle 804, and after the DRX inactivity timer has expired, the third data traffic 812 can remain in the buffer component of the base station 108 until the next PDCCH 818 of the next long DRX cycle, which can occur 160 ms after the occurrence of the long DRX cycle 804, however, that does not satisfy the PDB of 100 ms, resulting in QoS associated with the data traffic not being satisfied.

The data pattern determination component 206 can analyze the data traffic, and can determine the data traffic arrival pattern based at least in part on the results of the analysis of the data traffic, including determining that the first data traffic 808 can arrive and be ready for communication to the device 110 at the first time prior to the long DRX cycle 804, the second data traffic 810 can arrive and be ready for communication to the device 110 at the second time after the long DRX cycle 804 but during the time period of the DRX inactivity timer, and the third data traffic 812 can be at the base station 108 at the third time after the long DRX cycle 804 and after the DRX inactivity timer has expired.

The DRX cycle manager component 208 can analyze the data traffic arrival pattern, the PDB associated with the data traffic, the long DRX cycle 804, and the DRX inactivity timer. Based at least in part on the results of analyzing the data traffic arrival pattern, PDB, long DRX cycle 804, and DRX inactivity timer, the DRX cycle manager component 208 can determine that the configured DRX pattern 802 may not desirably satisfy the data traffic carried by the 5QI flow where the 5QI value can be, for example, 1 or 2. For instance, based at least in part on the results of such analysis, the DRX cycle manager component 208 can determine that, since the PDB associated with the data traffic (e.g., voice data traffic) can tolerate only up to 100 ms of data packet delay, the long DRX cycle duration is 160 ms, and the short DRX cycle is disabled, the PDB can be satisfied and power consumption by the device 110 can be reduced by decreasing the long DRX cycle duration to less than 100 ms (e.g., to 80 ms), or enabling a short DRX cycle, or increasing the amount of time of the DRX inactivity timer.

As disclosed, using RRC signaling to modify the long DRX cycle duration, enable the short DRX cycle, or modifying the DRX inactivity timer can be undesirable (e.g., inefficient, time consuming (e.g., may take hundreds of milliseconds), and expensive). Further, faster modification of DRX patterns and DRX cycles can be desirable, as data traffic arrival patterns often can change such that a DRX modification using RRC signaling may no longer even be useful by the time it is implemented.

In accordance with various embodiments, the DRX cycle manager component 208 desirably can utilize a MAC CE (e.g., MAC CE value) and/or DCI (e.g., a DCI value of a DCI bit) to manage the DRX pattern to modify the configured DRX pattern 802 to a modified DRX pattern 820 where the long DRX cycle duration can be decreased to less than 100 ms (e.g., to 80 ms), or a modified DRX pattern 840 where a short DRX cycle can be enabled, or a modified DRX pattern 860 where the amount of time of the DRX inactivity timer can be increased such that the respective items of data traffic associated with the device 110 can be communicated to the device 110 to satisfy the PDB. For instance, based at least in part on the results of analyzing the data traffic arrival pattern, PDB, long DRX cycle 804, and DRX inactivity timer, the DRX cycle manager component 208 can determine the modified DRX pattern 820 where the long DRX cycle duration can be decreased to, for example, 80 ms, such that a first long DRX cycle 822 can be followed by a second long DRX cycle 824 80 ms later, in accordance with the modified (e.g., decreased) long DRX cycle duration, and wherein the DRX inactivity timer can continue to have a duration of 20 ms (e.g., the same DRX inactivity timer as the DRX pattern 802), as indicated at reference numeral 826.

To facilitate implementing the modified DRX pattern 820, the DRX cycle manager component 208 desirably can communicate, to the device 110, a desired (e.g., suitable or corresponding) first MAC CE value to modify (e.g., decrease) the long DRX cycle duration to the desired modified long DRX cycle duration (e.g., 80 ms). For example, the DRX cycle manager component 208 can insert the first MAC CE value (e.g., 00111 associated with ms80) that can correspond to the modified (e.g., decreased) long DRX cycle duration into the cycle duration field (e.g., cycle duration field 304) of the MAC CE (e.g., MAC CE 300) for the long DRX cycle.

The DRX cycle manager component 208 can communicate, to the device 110, the MAC CE (e.g., associated with the long DRX cycle), comprising the first MAC CE value, for modifying (e.g., decreasing) the long DRX cycle duration, in accordance with the modified DRX pattern 820. The device 110 can receive the MAC CE, comprising the first MAC CE value, from the base station 108. The device 110, employing the DRX configuration component 116, can modify (e.g., reconfigure) the long DRX cycle duration to have the shorter long DRX cycle duration (e.g., 80 ms), based at least in part on the first MAC CE value contained in the MAC CE, in accordance with the modified DRX pattern 820.

Subsequently, in accordance with the data traffic arrival pattern, fourth data traffic 828 can arrive (e.g., can be received and buffered at the base station 108 and ready for communication to the device 110) at a fourth time prior to the first long DRX cycle 822, fifth data traffic 830 can arrive at a fifth time during the DRX inactivity timer period and prior to expiration of the DRX inactivity timer, and sixth data traffic 832 can arrive at a sixth time prior to the second long DRX cycle 824, in accordance with the data traffic arrival pattern and the modified DRX pattern 820. In accordance with the modified DRX pattern 820, when the base station 108 receives the fourth data traffic 828, the base station 108 can buffer the fourth data traffic 828 in the buffer component, and can schedule communication of the fourth data traffic 828 to the device 110 to occur during the on-duration of the first long DRX cycle 822 when the device 110 can be monitoring for PDCCH (e.g., fourth PDCCH 834). In accordance with such scheduling, the base station 108 can communicate the fourth data traffic 828 to the device 110 during the on-duration of the first long DRX cycle 822, and the device 110 can have its receiver component in the on state to monitor for the fourth PDCCH 834, and can receive the fourth data traffic 828 during that time. In accordance with the modified DRX pattern 820, when the base station 108 receives the fifth data traffic 830, the base station 108 can buffer the fifth data traffic 830 in the buffer component, and can schedule communication of the fifth data traffic 830 to the device 110 to occur during the DRX inactivity timer period of the DRX inactivity timer associated with the first long DRX cycle 822 when the device 110 can be monitoring for PDCCH (e.g., fifth PDCCH 836). In accordance with such scheduling, the base station 108 can communicate the fifth data traffic 830 to the device 110 during the DRX inactivity timer period of the DRX inactivity timer associated with the first long DRX cycle 822, and the device 110 can have its receiver component in the on state to monitor for the fifth PDCCH 836, and can receive the fifth data traffic 830 during that time. In accordance with the modified DRX pattern 820, when the base station 108 receives the sixth data traffic 832, the base station 108 can buffer the sixth data traffic 832 in the buffer component, and can schedule communication of the sixth data traffic 832 to the device 110 to occur during the on-duration of the second long DRX cycle 824 when the device 110 can be monitoring for PDCCH (e.g., sixth PDCCH 838). In accordance with such scheduling, the base station 108 can communicate the sixth data traffic 832 to the device 110 during the on-duration of the second long DRX cycle 824, and the device 110 can have its receiver component in the on state to monitor for the sixth PDCCH 838, and can receive the sixth data traffic 832 during that time.

Alternatively, based at least in part on the results of analyzing the data traffic arrival pattern, PDB, long DRX cycle 804, and DRX inactivity timer, the DRX cycle manager component 208 can determine the modified DRX pattern 840 where the short DRX cycle 842 can be enabled such that the modified DRX pattern can comprise a long DRX cycle 844 and the short DRX cycle 842, wherein there can be a long DRX cycle duration of 160 ms between the long DRX cycle 844 and a next long DRX cycle (not shown), and wherein the short DRX cycle 842 can occur (e.g., the on-duration of the short DRX cycle 842 can begin) 80 ms after the long DRX cycle 844. The modified DRX pattern 840 can have a DRX inactivity timer with a duration of 20 ms (e.g., the same DRX inactivity timer as the DRX pattern 802), as indicated at reference numeral 846.

To facilitate implementing the modified DRX pattern 840, the DRX cycle manager component 208 desirably can communicate, to the device 110, a desired (e.g., suitable or corresponding) second MAC CE value or a desired DCI bit value to enable the short DRX cycle 842. For example, the DRX cycle manager component 208 can insert a certain value that can correspond to enabling the short DRX cycle 842 into the MAC CE (e.g., MAC CE 400) for the short DRX cycle or can utilize a DCI bit value (e.g., 1), which can be an enable value, as part of the DCI, to facilitate enabling the short DRX cycle 842.

The DRX cycle manager component 208 can communicate, to the device 110, the MAC CE (e.g., associated with the short DRX cycle), comprising the second MAC CE value, or the DCI, comprising the desired DCI bit value, for enabling the short DRX cycle 842, in accordance with the modified DRX pattern 840. The device 110 can receive the MAC CE, comprising the second MAC CE value, or the DCI, comprising the desired DCI bit value (e.g., enable value), from the base station 108. The device 110, employing the DRX configuration component 116, can modify (e.g., reconfigure) the DRX pattern 802 to the modified DRX pattern 840 to enable the short DRX cycle 842, based at least in part on the second MAC CE value or desired DCI bit value, in accordance with the modified DRX pattern 840.

Subsequently, in accordance with the data traffic arrival pattern, fourth data traffic 848 can arrive (e.g., can be received at the base station 108 and ready for communication to the device 110) at a fourth time prior to the long DRX cycle 844, fifth data traffic 850 can arrive at a fifth time during the DRX inactivity timer period and prior to expiration of the DRX inactivity timer, and sixth data traffic 852 can arrive at a sixth time prior to the short DRX cycle 842, in accordance with the data traffic arrival pattern and the modified DRX pattern 840. In accordance with the modified DRX pattern 840, when the base station 108 receives the fourth data traffic 848, the base station 108 can buffer the fourth data traffic 848 in the buffer component, and can schedule communication of the fourth data traffic 848 to the device 110 to occur during the on-duration of the long DRX cycle 844 when the device 110 can be monitoring for PDCCH (e.g., fourth PDCCH 854). In accordance with such scheduling, the base station 108 can communicate the fourth data traffic 848 to the device 110 during the on-duration of the long DRX cycle 844, and the device 110 can have its receiver component in the on state to monitor for the fourth PDCCH 854, and can receive the fourth data traffic 848 during that time. In accordance with the modified DRX pattern 840, when the base station 108 receives the fifth data traffic 850, the base station 108 can buffer the fifth data traffic 850 in the buffer component, and can schedule communication of the fifth data traffic 850 to the device 110 to occur during the DRX inactivity timer period of the DRX inactivity timer associated with the long DRX cycle 844 when the device 110 can be monitoring for PDCCH (e.g., fifth PDCCH 856). In accordance with such scheduling, the base station 108 can communicate the fifth data traffic 850 to the device 110 during the DRX inactivity timer period of the DRX inactivity timer associated with the long DRX cycle 844, and the device 110 can have its receiver component in the on state to monitor for the fifth PDCCH 856, and can receive the fifth data traffic 850 during that time. In accordance with the modified DRX pattern 840, when the base station 108 receives the sixth data traffic 852, the base station 108 can buffer the sixth data traffic 852 in the buffer component, and can schedule communication of the sixth data traffic 852 to the device 110 to occur during the on-duration of the short DRX cycle 842 when the device 110 can be monitoring for PDCCH (e.g., sixth PDCCH 858). In accordance with such scheduling, the base station 108 can communicate the sixth data traffic 852 to the device 110 during the on-duration of the short DRX cycle 842, and the device 110 can have its receiver component in the on state to monitor for the sixth PDCCH 858, and can receive the sixth data traffic 852 during that time.

Alternatively, based at least in part on the results of analyzing the data traffic arrival pattern, PDB, long DRX cycle 804, and DRX inactivity timer, the DRX cycle manager component 208 can determine the modified DRX pattern 860 where the amount of time of the DRX inactivity timer can be increased such that the respective items of data traffic (e.g., corresponding to the data traffic arrival pattern) associated with the device 110 can be communicated to the device 110 to satisfy the PDB. For instance, based at least in part on the results of analyzing the data traffic arrival pattern, PDB, long DRX cycle 804, and DRX inactivity timer, the DRX cycle manager component 208 can determine the modified DRX pattern 860 where there can be a long DRX cycle duration of 160 ms between the long DRX cycle 862 and a next long DRX cycle (not shown), and wherein the DRX inactivity timer can be modified to increase the DRX inactivity timer duration from 20 ms to 40 ms. In accordance with the data traffic arrival pattern and the modified DRX pattern 860, there can be a first DRX inactivity timer that can have the DRX inactivity timer duration, as indicated at reference numeral 864, and a second DRX inactivity timer that can have the DRX inactivity timer duration, as indicated at reference numeral 866. It is noted that the first DRX inactivity timer 864 and second DRX inactivity timer 866 can be the same timer having the same DRX inactivity timer duration (e.g., 40 ms), wherein the first DRX inactivity timer 864 can cover (e.g., span) a first DRX inactivity time period, and the second DRX inactivity timer 866 can cover a second DRX inactivity time period.

To facilitate implementing the modified DRX pattern 860, the DRX cycle manager component 208 desirably can communicate, to the device 110, a desired (e.g., suitable or corresponding) third MAC CE value to modify (e.g., increase) the DRX inactivity timer duration to the desired modified DRX inactivity timer duration (e.g., 40 ms). For example, the DRX cycle manager component 208 can insert the third MAC CE value (e.g., 001011 associated with ms40) that can correspond to the modified (e.g., increased) DRX inactivity timer duration into the cycle duration field (e.g., timer field 504) of the MAC CE (e.g., MAC CE 500) for the DRX inactivity timer.

The DRX cycle manager component 208 can communicate, to the device 110, the MAC CE (e.g., associated with the DRX inactivity timer), comprising the third MAC CE value, for modifying (e.g., increasing) the DRX inactivity timer duration, in accordance with the modified DRX pattern 860. The device 110 can receive the MAC CE, comprising the third MAC CE value, from the base station 108. The device 110, employing the DRX configuration component 116, can modify (e.g., reconfigure) the DRX inactivity timer to have the desired increased DRX inactivity timer duration (e.g., 40 ms), based at least in part on the third MAC CE value contained in the MAC CE, in accordance with the modified DRX pattern 860.

Subsequently, in accordance with the data traffic arrival pattern, fourth data traffic 868 can arrive (e.g., can be received at the base station 108 and ready for communication to the device 110) at a fourth time prior to the long DRX cycle 862, fifth data traffic 870 can arrive at a fifth time during a first DRX inactivity timer period and prior to expiration of the first DRX inactivity timer 864, and sixth data traffic 872 can arrive at a sixth time during a second DRX inactivity timer period and prior to expiration of the second DRX inactivity timer 866, in accordance with the data traffic arrival pattern and the modified DRX pattern 860. In accordance with the modified DRX pattern 860, when the base station 108 receives the fourth data traffic 868, the base station 108 can buffer the fourth data traffic 868 in the buffer component, and can schedule communication of the fourth data traffic 868 to the device 110 to occur during the on-duration of the long DRX cycle 862 when the device 110 can be monitoring for PDCCH (e.g., fourth PDCCH 874). In accordance with such scheduling, the base station 108 can communicate the fourth data traffic 868 to the device 110 during the on-duration of the long DRX cycle 862, and the device 110 can have its receiver component in the on state to monitor for the fourth PDCCH 874, and can receive the fourth data traffic 868 during that time. In accordance with the modified DRX pattern 860, when the base station 108 receives the fifth data traffic 870, the base station 108 can buffer the fifth data traffic 870 in the buffer component, and can schedule communication of the fifth data traffic 870 to the device 110 to occur during the first DRX inactivity timer period of the first DRX inactivity timer 864 associated with the long DRX cycle 862 when the device 110 can be monitoring for PDCCH (e.g., fifth PDCCH 876). In accordance with such scheduling, the base station 108 can communicate the fifth data traffic 870 to the device 110 during the first DRX inactivity timer period of the first DRX inactivity timer 864 associated with the long DRX cycle 862, and the device 110 can have its receiver component in the on state to monitor for the fifth PDCCH 876, and can receive the fifth data traffic 870 during that time. In accordance with the modified DRX pattern 860, when the base station 108 receives the sixth data traffic 872, the base station 108 can buffer the sixth data traffic 872 in the buffer component, and can schedule communication of the sixth data traffic 872 to the device 110 to occur during the second DRX inactivity timer period of the second DRX inactivity timer 866 when the device 110 can be monitoring for PDCCH (e.g., sixth PDCCH 878). In accordance with such scheduling, the base station 108 can communicate the sixth data traffic 872 to the device 110 during the second DRX inactivity timer period of the second DRX inactivity timer 866, and the device 110 can have its receiver component in the on state to monitor for the sixth PDCCH 878, and can receive the sixth data traffic 872 during that time.

The DRX manager component 114, by modifying the configured DRX pattern 802 to the modified DRX pattern (e.g., 820, 840, or 860), can reduce the amount of power consumed by the device 110 while satisfying the PDB associated with the data traffic, enhance performance of the device 110, and enhance performance of the communication network 102. The DRX manager component 114 can continue to monitor the data traffic to facilitate determining whether the data traffic arrival pattern associated with the data traffic changes and/or determining whether to modify the modified DRX pattern (e.g., 820, 840, or 860), in accordance with the defined DRX management criteria.

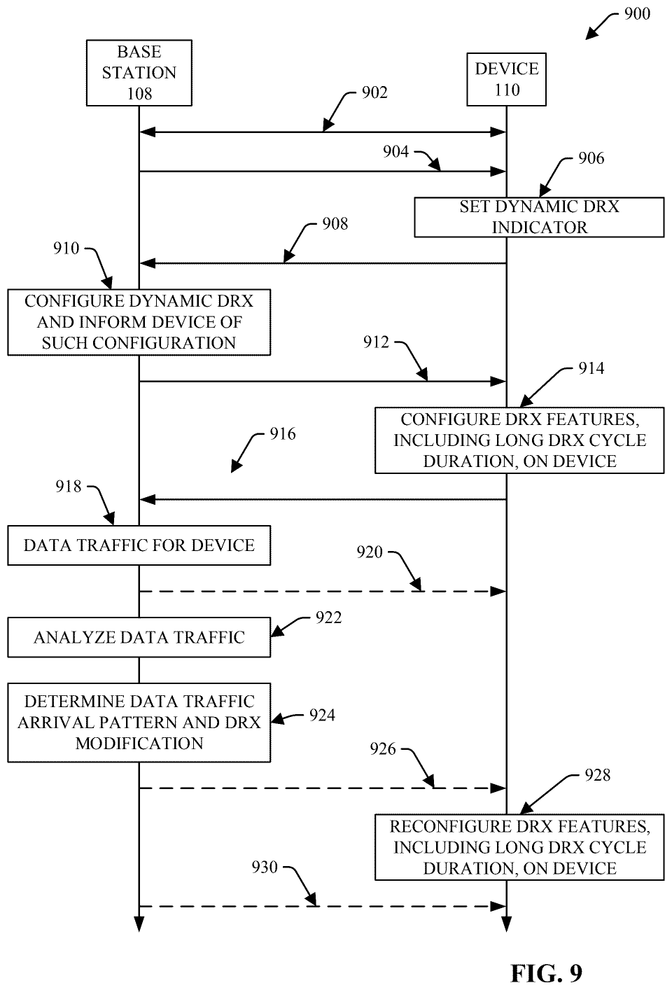

Turning to FIG. 9 (along with FIGS. 1-5), FIG. 9 depicts a diagram of a non-limiting example DRX management flow process 900 relating to desirable management of DRX in connection with communication of data traffic, comprising video data traffic (e.g., non-conversational video data traffic), to the device 110, in accordance with various aspects and embodiments of the disclosed subject matter. As indicated at reference numeral 902 of the DRX management flow process 900, RRC and non-access stratum (NAS) signaling can be communicated between the base station 108 and the device 110 to facilitate establishing a communication session between the base station 108 and the device 110 and configuring of the base station 108 and the device 110 with regard to the communication session.

As indicated at reference numeral 904 of the DRX management flow process 900, the base station 108 (e.g., employing the DRX manager component 114) can communicate a device (e.g., UE) capability inquiry to the device 110 to inquire as to the capabilities of the device 110 with regard to DRX features (e.g., dynamic DRX features). As indicated at reference numeral 906, the device 110 (e.g., employing the DRX configuration component 116) can set a DRX capability indicator (e.g., a dynamic DRX capability flag or indicator) that can indicate the device 110 supports dynamic DRX features (e.g., long DRX cycle, short DRX cycle, enabling or disabling of DRX cycles, and/or modification of DRX inactivity timers can be supported by the device 110), if the device 110 does support such dynamic DRX features. As indicated at reference numeral 908, the device 110 can communicate, to the base station 108, device capability information that can indicate whether the device 110 can support such dynamic DRX features. In the example scenario presented with regard to the example DRX management flow process 900, the device capability information can indicate that the device 110 can support such dynamic DRX features (e.g., UE capability information (dynamic DRX=supported)).

As indicated at reference numeral 910 of the DRX management flow process 900, the base station 108 (e.g., employing the DRX manager component 114) can determine and configure the dynamic DRX features with respect to the device 110 and communication session, and can generate an RRC configuration message (e.g., RRC signal comprising the RRC configuration message) that can indicate that the dynamic DRX features have been configured with respect to the device 110 and communication session. The RRC configuration message can comprise the DRX parameters (e.g., initial DRX parameters) for the communication session, wherein the DRX parameters can comprise information relating to the long DRX cycle, the DRX inactivity timer, and/or the short DRX cycle (e.g., enable or disable value for the enabling or disabling the short DRX cycle, and/or other short DRX cycle parameters if the short DRX cycle is enabled). In this example scenario presented with regard to the example DRX management flow process 900, the short DRX cycle can be enabled. As indicated at reference numeral 912, the base station 108 (e.g., employing the DRX manager component 114) can communicate the RRC configuration message to the device 110, wherein the RRC configuration message can comprise DRX configuration information relating to a configured DRX pattern, wherein the DRX configuration information can indicate that the short DRX cycle is enabled and the dynamic DRX features have been configured with respect to the device 110 and communication session (e.g., RRC configuration (or reconfiguration) with short DRX cycle and dynamic DRX=TRUE).

As indicated at reference numeral 914 of the DRX management flow process 900, the device 110 (e.g., employing the DRX configuration component 116) can configure the device 110 for the communication session, including configuring the device 110 with regard to the DRX features, comprising configuring (e.g., setting) a long DRX cycle having a desired long DRX cycle duration (e.g., 160 ms), enabling the short DRX cycle, and/or configuring the DRX inactivity timer to a desired DRX inactivity timer period, in accordance with the configured DRX pattern. As indicated at reference numeral 916, the device 110 (e.g., employing the DRX configuration component 116) can communicate an RRC configuration complete message to the base station 108 to inform the base station 108 (e.g., the DRX manager component 114 of or associated with the base station 108) that configuration of the device 110, including configuration of the DRX features associated with the device 110, in accordance with the configured DRX pattern, is complete (e.g., has been successfully completed).

As indicated at reference numeral 918 of the DRX management flow process 900, the base station 108 (e.g., the DRX manager component 114 of or associated with the base station 108) can receive (e.g., from the core network 104) data traffic (e.g., mobile terminating data), comprising non-conversational video data, associated with the device 110 during the communication session. As indicated at reference numeral 920, the base station 108 (e.g., the DRX manager component 114 of or associated with the base station 108), employing PDCCH, can communicate DCI, with the DCI bit for the short DRX cycle set to enable the short DRX cycle (e.g., DCI bit set to 1) (or with DCI that contains no DRX modification information since there is no modification to the configured DRX pattern at this time), to the device 110, and can communicate the data traffic (e.g., downlink data traffic) to the device 110, in accordance with the configured DRX pattern and the DCI.

As indicated at reference numeral 922 of the DRX management flow process 900, the base station 108 (e.g., the DRX manager component 114 of or associated with the base station 108) can analyze the data traffic (e.g., the mobile terminating data), comprising the non-conversational video data, associated with the device 110. As indicated at reference numeral 924, based at least in part on the analysis of the data traffic and/or the configured DRX pattern, the base station 108 (e.g., the DRX manager component 114 of or associated with the base station 108) can determine a data traffic arrival pattern of the data traffic, and can determine that a modification to the configured DRX pattern can satisfy the PDB associated with the data traffic while also reducing power consumed by the device 110 (and/or otherwise enhancing performance of the device 110, the RAN 106, and/or the communication network 102), in accordance with the defined DRX management criteria. In this example scenario, the modification to the configured DRX pattern (e.g., modified DRX pattern) can comprise, for example, disabling the short DRX cycle and increasing the long DRX cycle duration of the long DRX cycles (e.g., from 160 ms to 256 ms), such as described herein.

As indicated at reference numeral 926 of the DRX management flow process 900, the base station 108 (e.g., the DRX manager component 114 of or associated with the base station 108), employing PDCCH, can communicate, to the device 110, DCI, with the DCI bit for the short DRX cycle set to facilitate disabling the short DRX cycle (e.g., DCI bit set to 0) and with a MAC CE comprising a MAC CE value (e.g., 01010 associated with ms256) to facilitate modifying the cycle duration (e.g., 160 ms) of the long DRX cycle to a modified cycle duration (e.g., 256 ms). As indicated at reference numeral 928, the device 110 (e.g., employing the DRX configuration component 116) can reconfigure the device 110 for the communication session, including modifying (e.g., reconfiguring) the long DRX cycle having a modified (e.g., increased) long DRX cycle duration (e.g., 256 ms) and disabling the short DRX cycle, based at least in part on (e.g., in accordance with) the MAC CE value and the DCI bit value, in accordance with the modified DRX pattern.

As indicated at reference numeral 930 of the DRX management flow process 900, the base station 108 (e.g., the DRX manager component 114 of or associated with the base station 108), employing PDCCH, can communicate, to the device 110, DCI, with no change in the DRX parameters, to facilitate maintaining the cycle duration of the long DRX cycle at the modified cycle duration (e.g., 256 ms) and maintaining the short DRX cycle in the disabled mode (e.g., assuming and provided that the DRX manager component 114 has not determined that the modified DRX pattern is to be changed to another modified DRX pattern). During the communication session, the DRX manager component 114 can continue to monitor and analyze the data traffic associated with the device 110 to facilitate determining whether the data traffic arrival pattern has changed. If, based at least in part on such analysis of the data traffic, the DRX manager component 114 determines that there has been a change to the data traffic arrival pattern, and determines that the modified DRX pattern is to be changed to another modified DRX pattern, in accordance with the defined DRX management criteria, the DRX manager component 114 can generate, and can communicate to the device 110, DCI, comprising updated DRX parameter values relating to the long DRX cycle, the short DRX cycle, the DRX inactivity timer, and/or other DRX function or feature, to facilitate changing (e.g., reconfiguring by the DRX configuration component 116 of the device 110) the modified DRX pattern to the other (e.g., updated or further modified) DRX pattern.

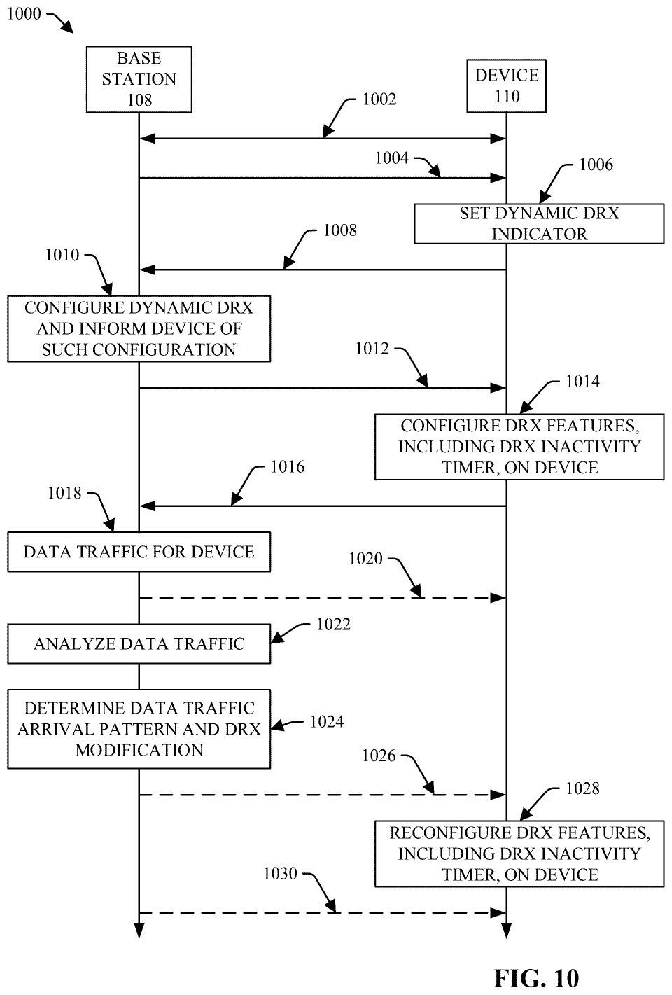

Referring to FIG. 10 (along with FIGS. 1-5), FIG. 10 illustrates a diagram of a non-limiting example DRX management flow process 1000 relating to desirable management of DRX in connection with communication of data traffic, comprising voice data traffic (e.g., conversational voice data traffic), to the device 110, in accordance with various aspects and embodiments of the disclosed subject matter. Some of the aspects of the example DRX management flow process 1000 can be same as or similar to the example DRX management flow process 900 of FIG. 9, except that there can be differences due in part to the example DRX management flow process 1000 relating to voice data traffic, whereas the example DRX management flow process 1000 relates to video data traffic.

As indicated at reference numeral 1002 of the DRX management flow process 1000, RRC and NAS signaling can be communicated between the base station 108 and the device 110 to facilitate establishing a communication session between the base station 108 and the device 110 and configuring of the base station 108 and the device 110 with regard to the communication session. As indicated at reference numeral 1004, the base station 108 (e.g., employing the DRX manager component 114) can communicate a device capability inquiry to the device 110 to inquire as to the capabilities of the device 110 with regard to DRX features (e.g., dynamic DRX features).

As indicated at reference numeral 1006 of the DRX management flow process 1000, the device 110 (e.g., employing the DRX configuration component 116) can set a DRX capability indicator (e.g., a dynamic DRX capability flag or indicator) that can indicate the device 110 supports dynamic DRX features (e.g., long DRX cycle, short DRX cycle, enabling or disabling of DRX cycles, and/or modification of DRX inactivity timers can be supported by the device 110), if the device 110 does support such dynamic DRX features. As indicated at reference numeral 1008, the device 110 can communicate, to the base station 108, device capability information that can indicate whether the device 110 can support such dynamic DRX features. In the example scenario presented with regard to the example DRX management flow process 1000, the device capability information can indicate that the device 110 can support such dynamic DRX features (e.g., UE capability information (dynamic DRX=supported)).

As indicated at reference numeral 1010 of the DRX management flow process 1000, the base station 108 (e.g., employing the DRX manager component 114) can determine and configure the dynamic DRX features with respect to the device 110 and communication session, and can generate an RRC configuration message (e.g., RRC signal comprising the RRC configuration message) that can indicate that the dynamic DRX features have been configured with respect to the device 110 and communication session. The RRC configuration message can comprise the DRX parameters (e.g., initial DRX parameters) for the communication session, wherein the DRX parameters can comprise information relating to the long DRX cycle, the DRX inactivity timer, and/or the short DRX cycle (e.g., enable or disable value for the enabling or disabling the short DRX cycle, and/or other short DRX cycle parameters if the short DRX cycle is enabled). In this example scenario presented with regard to the example DRX management flow process 1000, the long DRX cycle can be set to have a desired cycle duration of 160 ms, the short DRX cycle can be disabled, and the DRX inactivity timer can be set to have a desired inactivity timer period of 20 ms. As indicated at reference numeral 1012, the base station 108 (e.g., employing the DRX manager component 114) can communicate the RRC configuration message to the device 110, wherein the RRC configuration message can comprise DRX configuration information relating to a configured DRX pattern, wherein the DRX configuration information can indicate that the long DRX cycle can be set to have the desired cycle duration of 160 ms, the short DRX cycle can be disabled, and the DRX inactivity timer can be set to the desired DRX inactivity timer period of 20 ms, and can further indicate that the dynamic DRX features have been configured with respect to the device 110 and communication session (e.g., RRC configuration (or reconfiguration) with short DRX cycle and dynamic DRX=TRUE).

As indicated at reference numeral 1014 of the DRX management flow process 1000, the device 110 (e.g., employing the DRX configuration component 116) can configure the device 110 for the communication session, including configuring the device 110 with regard to the DRX features, comprising configuring (e.g., setting) a long DRX cycle having a desired long DRX cycle duration (e.g., 160 ms), disabling the short DRX cycle, and/or configuring the DRX inactivity timer to the desired DRX inactivity timer period of 20 ms, in accordance with the configured DRX pattern. As indicated at reference numeral 1016, the device 110 (e.g., employing the DRX configuration component 116) can communicate an RRC configuration complete message to the base station 108 to inform the base station 108 (e.g., the DRX manager component 114 of or associated with the base station 108) that configuration of the device 110, including configuration of the DRX features associated with the device 110, in accordance with the configured DRX pattern, is complete (e.g., has been successfully completed).

As indicated at reference numeral 1018 of the DRX management flow process 1000, the base station 108 (e.g., the DRX manager component 114 of or associated with the base station 108) can receive (e.g., from the core network 104) data traffic (e.g., mobile terminating data), comprising voice data, associated with the device 110 during the communication session. As indicated at reference numeral 1020, the base station 108 (e.g., the DRX manager component 114 of or associated with the base station 108), employing PDCCH, can communicate, to the device 110, DCI, with no change in the DRX parameters, to facilitate maintaining the cycle duration of the long DRX cycle at the cycle duration (e.g., 160 ms), maintaining the short DRX cycle in the disabled mode, and maintaining the DRX inactivity timer at 20 ms, and can communicate the data traffic (e.g., downlink data traffic) to the device 110, in accordance with the configured DRX pattern and the DCI.

As indicated at reference numeral 1022 of the DRX management flow process 1000, the base station 108 (e.g., the DRX manager component 114 of or associated with the base station 108) can analyze the data traffic (e.g., the mobile terminating data), comprising the conversational voice data, associated with the device 110. As indicated at reference numeral 1024, based at least in part on the analysis of the data traffic and/or the configured DRX pattern, the base station 108 (e.g., the DRX manager component 114 of or associated with the base station 108) can determine a data traffic arrival pattern of the data traffic, and can determine that a modification to the configured DRX pattern can satisfy the PDB associated with the data traffic while also reducing power consumed by the device 110 (and/or otherwise enhancing performance of the device 110, the RAN 106, and/or the communication network 102), in accordance with the defined DRX management criteria. In this example scenario, the modification to the configured DRX pattern (e.g., modified DRX pattern) can comprise, for example, modifying (e.g., adjusting, increasing, or reconfiguring) the DRX inactivity timer from 20 ms to 40 ms, such as described herein.

As indicated at reference numeral 1026 of the DRX management flow process 1000, the base station 108 (e.g., the DRX manager component 114 of or associated with the base station 108), employing PDCCH, can communicate, to the device 110, DCI, with a MAC CE comprising a MAC CE value (e.g., 001011 associated with ms40) to facilitate modifying the DRX inactivity timer (e.g., 20 ms) to a modified DRX inactivity timer (e.g., 40 ms). As indicated at reference numeral 1028, the device 110 (e.g., employing the DRX configuration component 116) can reconfigure the device 110 for the communication session, including modifying (e.g., reconfiguring) the DRX inactivity timer to a modified (e.g., increased) DRX inactivity timer (e.g., 40 ms), based at least in part on (e.g., in accordance with) the MAC CE value, in accordance with the modified DRX pattern.

As indicated at reference numeral 1030 of the DRX management flow process 1000, the base station 108 (e.g., the DRX manager component 114 of or associated with the base station 108), employing PDCCH, can communicate, to the device 110, DCI, with no change in the DRX parameters, to facilitate maintaining the DRX parameters, including the modified DRX inactivity timer (e.g., 40 ms), in accordance with the modified DRX pattern (e.g., assuming and provided that the DRX manager component 114 has not determined that the modified DRX pattern is to be changed to another modified DRX pattern). During the communication session, the DRX manager component 114 can continue to monitor and analyze the data traffic associated with the device 110 to facilitate determining whether the data traffic arrival pattern has changed. If, based at least in part on such analysis of the data traffic, the DRX manager component 114 determines that there has been a change to the data traffic arrival pattern, and determines that the modified DRX pattern is to be changed to another modified DRX pattern, in accordance with the defined DRX management criteria, the DRX manager component 114 can generate, and can communicate to the device 110, DCI, comprising updated DRX parameter values relating to the long DRX cycle, the short DRX cycle, the DRX inactivity timer, and/or other DRX function or feature, to facilitate changing (e.g., reconfiguring by the DRX configuration component 116 of the device 110) the modified DRX pattern to the other (e.g., updated or further modified) DRX pattern.

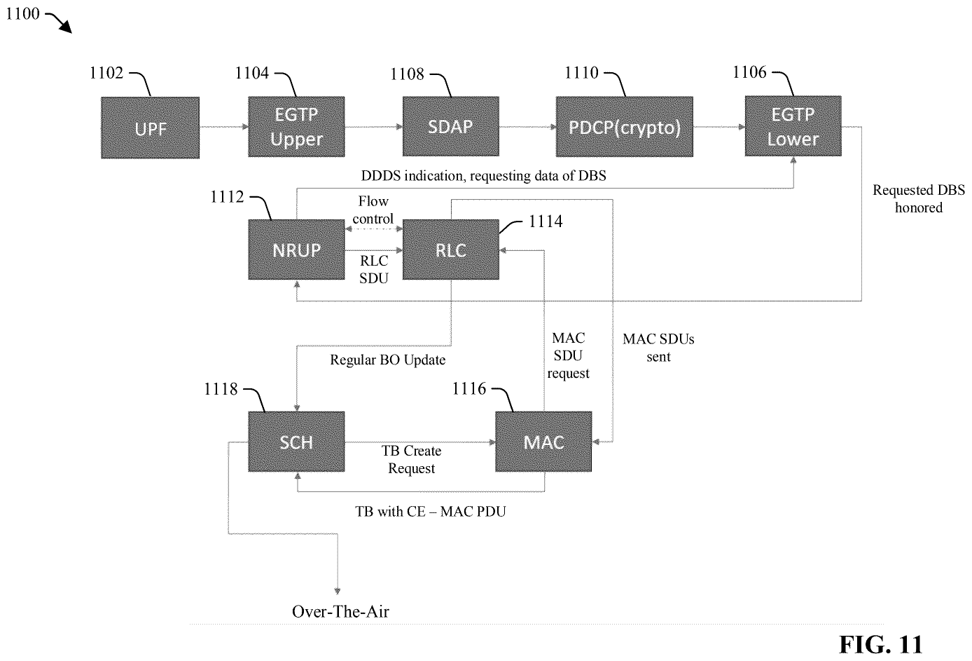

Turning to FIG. 11 (along with FIGS. 1-5), FIG. 11 illustrates a block diagram of non-limiting example network components 1100 that can introduce certain delays that can be associated with (e.g., can affect) the PDB associated with data traffic associated with a device and determination of a remaining PDB associated with the data traffic that can take into account such delays in connection with managing DRX parameters, in accordance with various aspects and embodiments of the disclosed subject matter. There can be a PDB that can be associated with data traffic associated with a device (e.g., device 110) based at least in part on the type of data traffic, type of service, QoS or 5QI associated with the data traffic, and/or another characteristic of factor associated with the data traffic, device 110, and/or service. In connection with communication of data traffic between the service (e.g., a device associated with the service), the communication network 102, and the device 110, there can be various respective types and amounts of delay that can occur with regard to respective processing of the data traffic at respective components (e.g., network components of the communication network 102) and communication of the data traffic between the various respective components. It can be desirable (e.g., suitable, wanted, necessary, or optimal) to take these various respective types and amounts of delay associated with these various respective components into account, for example, when determining a desired DRX pattern or a desired modification of a DRX pattern associated with the data traffic to enable the PDB (e.g., and associated QoS or 5QI) to be satisfied. For instance, it can be desirable for the DRX manager component 114 to determine a remaining DRB associated with data traffic associated with the device 110 based at least in part on the PDB and the various respective types and amounts of delay associated with these various respective components, and utilize the remaining PDB to facilitate determining a DRX pattern or a modification to a DRX pattern associated with the data traffic associated with the device 110.

For instance, with regard to the non-limiting example network components 1100, there can be various components (e.g., network-related functions or operations that can cause delay of communication of data traffic), such as core network 104, RAN 106, user plane function (UPF) 1102, CU-UP (not shown in FIG. 11; as more fully described herein), DU (not shown in FIG. 11; as more fully described herein), evolved general packet radio service (GPRS) tunneling protocol (eGTP) (e.g., eGTP upper 1104, and eGTP lower 1106), service data adaptation protocol (SDAP) 1108, packet data convergence protocol (PDCP) 1110, NRUP 1112, radio link control (RLC) 1114, MAC 1116, scheduler component (SCH) 1118, and/or other components.

The PDB determination component 212 can determine a remaining PDB associated with the data traffic based at least in part on the PDB associated with the data traffic and a group of network-related delay values or factors that can relate to these various components associated with the communication network. For example, PDB determination component 212 can determine (e.g., calculate) a remaining PDB associated with the data traffic based at least in part on (e.g., as function of) the PDB, the CN PDB value, the CU-UP delay value, the DDDS delay value, the DU delay value, the OTA delay value, and/or another delay value associated with the data traffic and the network components. The respective delay values can be on the order of milliseconds or tens of milliseconds. The remaining PDB can be an amount of PDB associated with the data traffic (e.g., that has arrived at the MAC 1116) that can remain after taking into account (e.g., after subtracting from the PDB) the respective amounts of delay associated with the respective delay values or factors of the group of delay values or factors.

The CN PDB value can be a static value (e.g., 20 ms or other amount of time) for the delay between a UPF terminating interface (e.g., UPF terminating N6 interface) and the RAN 106 (e.g., 5G-access network (AN)). The CU-UP delay value can be the amount of time taken for receiving the data packet on the eGTP interface, through the SDAP 1108, through the PDCP 1110, and out of the cryptographic engine of or associated with the PDCP 1110. The DDDS delay value can be or relate to, for example, the frequency at which a DDDS message can be sent from the DU to the CU-UP. The DU delay can be an amount of time relating to reading of the data packet from the eGTP, through the NRUP 1112, flow controlled and placed in the RLC queue of or associated with the RLC 1114. This can be followed by buffer occupancy (BO) reporting, MAC transport block (TB) preparation, and selection of the device (e.g., device 110) for scheduling of communication of the data packet, all of which can be part of the DU delay. The OTA delay that can be the amount of time for the data packet to travel over the air from the RAN 106 to the device 110.

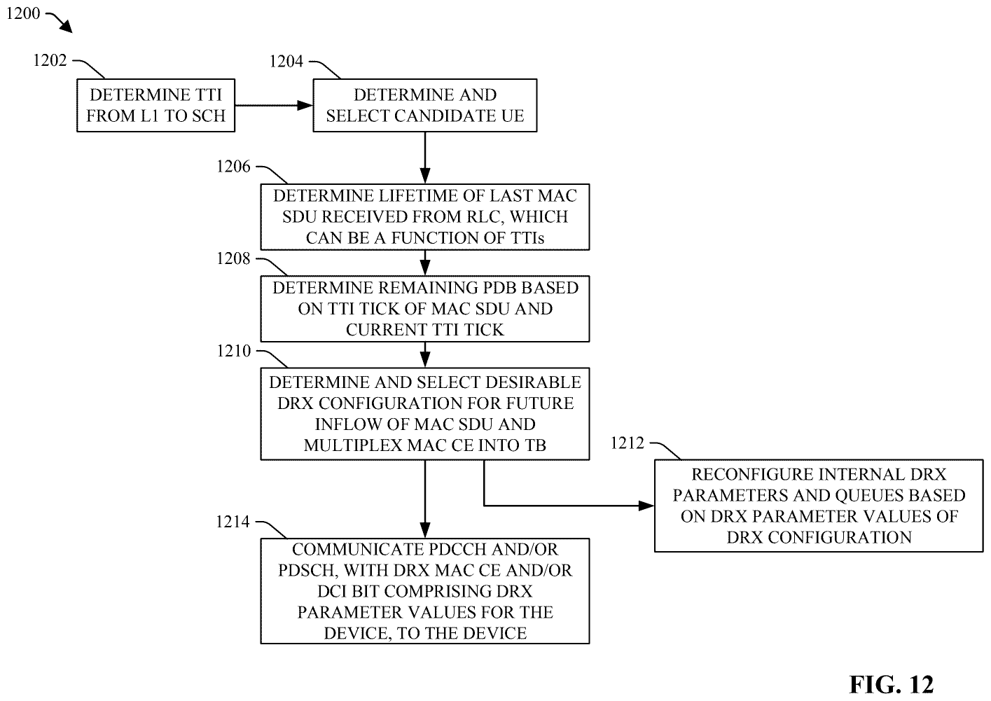

Referring to FIG. 12 (along with FIGS. 1-5 and 11), FIG. 12 depicts a block diagram of non-limiting example DRX cycle modification process 1200 for modification of a long DRX cycle period, associated with data traffic associated with a device, that can be based at least in part on a remaining PDB associated with the data traffic that can take into account network delay components that can reduce the PDB to the remaining PDB, in accordance with various aspects and embodiments of the disclosed subject matter. As indicated at reference numeral 1202 of the DRX cycle modification process 1200, the DRX manager component 114 can determine a transmission time interval (TTI) from the L1 layer (e.g., physical (PHY) layer) of the RAN 106 to the scheduler component (e.g., scheduler component 1118). As indicated at reference numeral 1204, the DRX manager component 114 can determine and select a candidate UE (e.g., device 110) for DRX configuration.

As indicated at reference numeral 1206 of the DRX cycle modification process 1200, the DRX manager component 114 can determine the lifetime of the last MAC service data unit (SDU) received from the RLC 1114, which can be a function of TTIs. As indicated at reference numeral 1208, the DRX manager component 114, employing the PDB determination component 212, can determine (e.g., calculate) the remaining PDB associated with the data traffic based at least in part on (e.g., as a function of) the TTI tick of the MAC SDU and the current TTI tick (e.g., by subtracting the TTI tick of the MAC SDU from the current TTI tick. As indicated at reference numeral 1210, with the remaining PDB determined, the DRX manager component 114, employing the PDB determination component 212, can determine and select a desirable (e.g., suitable, efficient, enhanced, or optimal) DRX configuration, comprising DRX parameter values (e.g., DRX cycle parameters values relating to long DRX cycle duration, enabling or disabling of the short DRX cycle, DRX inactivity timer duration, and/or other DRX parameters) for the device 110, for the future inflow of the MAC SDU and can multiplex the MAC CE into the TB, in accordance with the defined DRX management criteria.

As indicated at reference numeral 1212 of the DRX cycle modification process 1200, the DRX manager component 114 can reconfigure (e.g., modify, adjust, or adapt) the internal DRX parameters (e.g., DRX timer parameters or other DRX parameters) and queues based at least in part on the DRX parameters values of the DRX configuration determined and selected for the device 110. As indicated at reference numeral 1214, the base station 108, via or as facilitated by the DRX manager component 114, can communicate (e.g., send) the PDCCH and/or physical downlink shared channel (PDSCH), with the MAC CE and/or DCI bit, comprising the DRX parameter values for the device 110, to the device 110. The device 110 can configure (e.g., reconfigure, modify, adjust, or adapt) its DRX configuration (e.g., RRC signal-based DRX configuration) based at least in part on the DRX parameter values, such as described herein.

With further regard to the DRX manager component 114, in accordance with various embodiments, the DRX manager component 114 can comprise an artificial intelligence (AI) component 214. The AI component 214 can comprise a trainer component 216 and a model(s) 218 (e.g., one or more trained AI/machine learning (ML)-based models). The AI component 214 can perform an AI and/or ML-based analysis on data, such as information relating to communication sessions (e.g., previous or current communication sessions), including data traffic, DRX configurations, and DRX parameters, associated with devices (e.g., device 110 and/or device 112). In some embodiments, the AI component 214 can input such information relating to communication sessions to the (trained) ML model 218 for analysis by the ML model 218.

In connection with or as part of such an AI or ML-based analysis, the AI component 214 can employ, build (e.g., construct or create), and/or import, AI and/or ML techniques and algorithms, AI and/or ML models 218 (e.g., trained models), neural networks (e.g., trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about relationships between components (e.g., base stations, cells, network nodes, communication links, devices, or other components or functions) of or associated with the communication network 102, determining or learning about data traffic associated with a communication session between the base station and device, determine or learn a data traffic arrival pattern associated with the device, determine or learn a change in a data traffic arrival pattern associated with the device, determine or learning about DRX configurations associated with devices or data traffic (e.g., types of data traffic), determining or learning about respective power consumptions associated with respective DRX configurations associated with devices or data traffic, determine or learning about an effect on performance, QoS, 5QI, and/or power consumption as a result of modification of DRX parameters with regard to a communication session associated with the device, performing other desired functions or operations, and/or automating one or more functions or features of the disclosed subject matter, as more fully described herein.

The AI component 214 can employ various AI-based or ML-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 214 can examine the entirety or a subset of the data (e.g., the training data; the operational data relating to the communication network, the RAN, the devices, and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 214 and/or the trained model(s) 218 can employ one or more threshold probabilities (e.g., threshold probability values) to facilitate making a determination. For instance, in making a determination (e.g., relating to data traffic, DRX configuration, DRX parameter value, device, or other element or function), as part of the AI or ML-based analysis of information, the AI component 214 and/or the trained model(s) 218 can determine a probability (e.g., relating to data traffic, DRX configuration, DRX parameter value, device, or other element or function), and can determine whether the probability (e.g., probability value) satisfies (e.g., meets or exceeds; or is at or greater than) a defined and applicable threshold probability. The AI component 214 and/or the trained model(s) 218 can make a determination (or prediction or inference) (e.g., relating to data traffic, DRX configuration, DRX parameter value, device, or other element or function) based at least in part on the results of analyzing (e.g., comparing) the probability to the defined and applicable threshold probability (e.g., threshold minimum probability value). For example, the AI component 214 and/or the trained model(s) 218 can make a determination (or prediction or inference) that a particular group of DRX parameters can be employed to enhance performance associated with the device (e.g., reduce power consumption of the device and satisfy PDB associated with data traffic) based at least in part on determining that a probability relating to (e.g., indicating) whether the particular group of DRX parameters can enhance performance associated with the device satisfies the defined and applicable threshold probability (e.g., the probability is the highest probability, relative to other probabilities associated with other groups of DRX parameters, and satisfies the defined and applicable threshold probability).

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 214 can employ a classifier that can perform an AI-based analysis on data. A classifier can map an input attribute vector, z=(z1, z2, z3, z4, . . . , zn), to a confidence that the input belongs to a class, as by f (z)=confidence (class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 214 (e.g., employing the trainer component 216) can comprise, generate, and/or train ML models 218 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between components (e.g., base stations, cells, network nodes, communication links, devices, or other components or functions) of or associated with the communication network 102; data traffic (e.g., type of data traffic, amount of data traffic, or other characteristic of data traffic) associated with a communication session between the base station and device; a data traffic arrival pattern associated with the device; a change in a data traffic arrival pattern associated with the device; DRX configurations associated with devices or data traffic (e.g., types of data traffic); respective power consumptions associated with respective DRX configurations associated with devices or data traffic; and/or an effect on performance, QoS, 5QI, and/or power consumption as a result of modification of DRX parameters with regard to a communication session associated with the device; and/or to perform other desired functions or operations, and/or to automate one or more functions or features of the disclosed subject matter, as described herein.

For instance, the AI component 214 can employ the trainer component 216 that can train (or refine or update training of) a (trained) ML model(s) 218 to perform such learning, determinations, predictions, or inferences, and/or perform such other desired functions or operations, and/or automate such functions of features, based at least in part on application of training data and/or feedback information relating to communication sessions associated with devices to the (trained) ML model, wherein the training data and/or feedback information can comprise or relate to, for example, current or previous communication sessions associated with a device(s), services, data traffic associated with devices, DRX configurations and DRX parameters, power consumption associated with devices and/or communication network 102, the defined DRX management criteria, threshold values, and/or other data. Such training of the trained ML model(s) 218 can enable the trained ML model(s) 218 to perform an AI or ML-based analysis on information relating to communication sessions associated with devices, including a current communication session(s) associated with a device(s), wherein, based at least in part on the results of such AI or ML-based analysis, the trained ML model(s) 218 can learn, determine, predict, or infer data patterns in data; a correlation, relationship, or causation between an item(s) of data and another item(s) of data; a correlation, relationship, or causation between an event and another event (e.g., occurrence of another event); relationships between components (e.g., base stations, cells, network nodes, communication links, devices, or other components or functions) of or associated with the communication network 102; data traffic (e.g., type of data traffic, amount of data traffic, or other characteristic of data traffic) associated with a communication session between the base station and device; a data traffic arrival pattern associated with the device; a change in a data traffic arrival pattern associated with the device; DRX configurations associated with devices or data traffic (e.g., types of data traffic); respective power consumptions associated with respective DRX configurations associated with devices or data traffic; and/or an effect on performance, QoS, 5QI, and/or power consumption as a result of modification of DRX parameters with regard to a communication session associated with the device; and/or to perform other desired functions or operations, and/or to automate one or more functions or features of the disclosed subject matter.

In some embodiments, the AI component 214 (e.g., employing the trainer component 216) can update (e.g., modify, adjust, refine, or change), and further train and enhance, the trained ML model(s) 218 as additional data (e.g., information relating to further operation of, or modifications or changes to, the communication network 102, RAN 106, cells, devices, DRX manager component, DRX configurations, DRX parameters, data traffic, data traffic arrival patterns, QoS or 5QI associated with data traffic, power consumption associated with a device or the communication network 102, services, and/or other functions, features, or operations; output results output from the ML model(s) 218; the feedback information; and/or other information) is received and analyzed by the AI component 214 or trained ML model(s) 218. In some embodiments, as part of the data analysis, and the determining and training of the models 218, the AI component 214 can employ (and/or train) Markov chains, a neural network(s), decision trees, or other AI-based or ML-based modeling, techniques, functions, or algorithms.

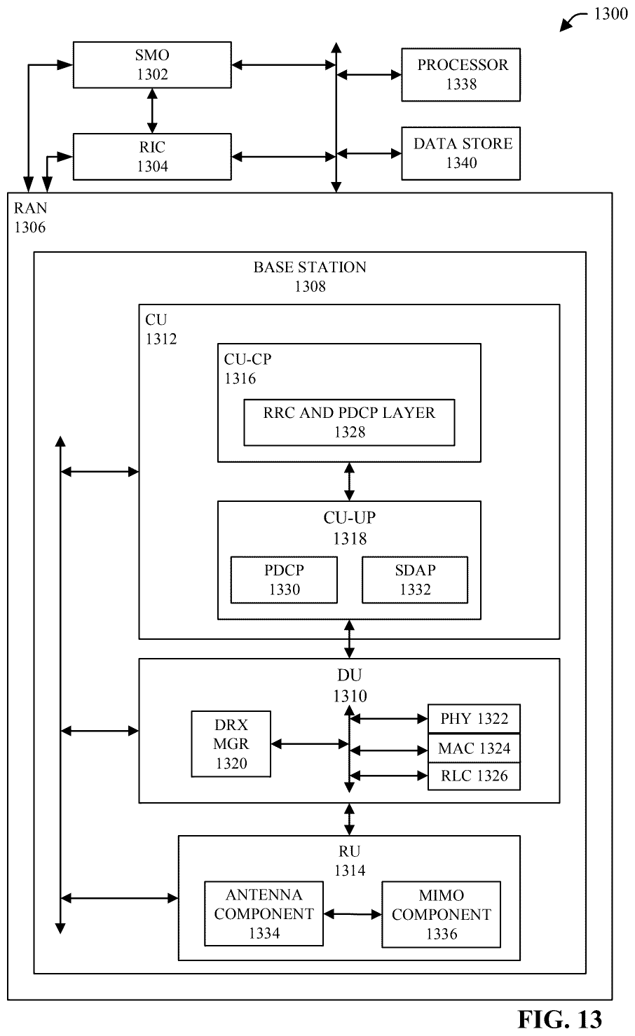

Turning to FIG. 13 (along with FIGS. 1 and 2), FIG. 13 depicts a block diagram of non-limiting example system 1300 that can comprise a DRX manager component in an O-RAN communication network environment to facilitate desirable (e.g., suitable, reliable, efficient, enhanced, and/or optimal) management of DRX associated with devices to achieve desirable communication performance and power savings, in accordance with various aspects and embodiments of the disclosed subject matter. In some embodiments, the system 1300 can be part of the system 100 depicted in FIG. 1.

The system 1300 can comprise a service management and orchestration (SMO) 1302, a RIC 1304, and a RAN 1306. In some embodiments, the RAN 1306 can be an O-RAN that can be part of an O-RAN architecture and environment (e.g., the communication network 102 can employ an O-RAN architecture and environment). In certain embodiments, the RAN 1306 can be a cloud-based or centralized RAN (C-RAN) that can be part of a cloud or centralized RAN (C-RAN), or a virtual RAN (vRAN) that can be part of a vRAN architecture and environment (e.g., the communication network 102 can employ a C-RAN or vRAN architecture and environment). In still other embodiments, the RAN 1306 may not be an O-RAN, C-RAN, or vRAN.

In accordance with various embodiments, the RAN 1306 and associated communication network (e.g., communication network 102) can be part of a 5G or other new radio (NR) communication environment (e.g., an xG communication environment, wherein x can be 5 or a number greater than 5). With regard to 5G or other NR generation, the RAN 1306 can comprise base stations, such as a gNodeB (gNB or NR-NB), that can be disaggregated into a CU (e.g., gNB or other NR-NB CU), comprising a CU-UP (e.g., gNB or other NR-NB CU-UP), a CU-control plane (CU-CP) (e.g., gNB or other NR-NB CU-CP), and a DU (e.g., gNB or other NR-NB DU). The CU-UP and DU can be part of the user plane node, with the CU-UP hosting PDCP and SDAP entities, and the DU can host the RLC, MAC, and PHY layers. For instance, the RAN 1306 can comprise the base station 1308 that can comprise a DU 1310, a CU 1312, and a radio unit (RU) 1314 (e.g., a gNB or other NR-NB RU). The CU 1312 can comprise a CU-CP 1316 (also referred to as a CU-CP node) and a CU-UP 1318 (also referred to as a CU-UP node). In certain embodiments, the RAN 1306 and/or the base station 1308 can comprise multiple DUs, multiple CU-CPs, multiple CU-UPS, and/or multiple RUs. In some embodiments, the DU 1310, the CU 1312, and the RU 1314 can be co-located at a cell site. In other embodiments, one or more of the components (e.g., the CU 1312, or at least part of the CU 1312, such as the CU-CP 1316) of the base station 1308 can be located in different location than one or more other components (e.g., DU 1310, RU 1314, and/or CU-UP 1318) of the base station 1308.

In accordance with various embodiments, the system 1300 can comprise the DRX manager component (DRX MGR) 1320 that can be associated with (e.g., communicatively connected to or part of) the DU 1310, the CU 1312, the RU 1314, or another component of or associated with the base station 1308. In some embodiments, the DRX manager component 1320 can be part of the DU 1310 (as depicted in FIG. 13). In other embodiments, the DRX manager component 1320 can be part of another component of or associated with the base station 1308 or RAN 1306. In still other embodiments, the DRX manager component 1320 can be a separate component in the RAN 1306 or base station 1308, and can be associated with the DU 1310 and/or one or more of the other components of the RAN 1306 or base station 1308. The DRX manager component 1320 can comprise various components and functions, and can perform various operations, such as described herein.

The DU 1310 can be a logical node that can host or handle baseband (e.g., PHY) 1322 and layer 2 (L2) (e.g., a MAC layer 1324 and a RLC layer 1326) functionality associated with the base station 1308. The CU-CP 1316 can be a logical node that can host or handle layer 3 (L3) (e.g., a RRC and PDCP layer 1328) control plane functionality associated with the base station 1308. The CU-UP 1318 can be a logical node that can host or handle data traffic between the core network 104 (e.g., 5G core network) and one or more DUs (e.g., the DU 1310) to which the CU-UP 1318 is connected. In some embodiments, the CU-UP 1318 can comprise a PDCP component (PDCP) 1330 that can perform PDCP functions, and an SDAP component (SDAP) 1332 that can perform SDAP functions.

The RU 1314 can be or can comprise a logical node that can host a lower PHY layer and RF processing, where signals (e.g., RF signals) can be transmitted, received, amplified, digitized, or otherwise processed, to facilitate communication of information (e.g., signals comprising information) between the RAN 1306 and other devices (e.g., devices 110 and/or 112) or components (e.g., components or functions of the core network 104 or communication network 102). In some embodiments, the RU 1314 can comprise an antenna component 1334 that can comprise an antenna array that can comprise a desired number of transmitter and receiver antennas to facilitate transmission and receiving of signals comprising information, and perform various beamforming, antenna-related, and communication-related functions. The RU 1314 also can comprise a MIMO component 1336 that can be employed to generate or modify a number of MIMO spatial layers and a number of spatial streams employed by the base station 1308 (e.g., with regard to a device(s)) during a communication session between the base station 1308 and a device (e.g., device 110), and perform MIMO spatial multiplexing functions. In certain embodiments, the MIMO component 1336 can be configured in a single user (SU)-type MIMO mode or a multiple user (MU)-type MIMO mode. In some embodiments, the MIMO component 1336 can employ or support massive MIMO (mMIMO). The RU 1314 also can comprise or be associated with other functions, including, for example, modulation and coding scheme (MCS) functions and transmit diversity functions.

In some embodiments, as disclosed, the system 1300 can comprise an O-RAN architecture and environment, and the RAN 1306 can be an O-RAN. In some embodiments, in the O-RAN architecture and environment, the SMO component 1302 can be associated with (e.g., communicatively connected to) the RIC 1304 and/or the RAN 1306 (and/or one or more other RANs) via an interface(s) (e.g., an O1 interface, an A1 interface, or another interface), to facilitate communication of information between the SMO component 1302 and the RIC 1304 and/or the RAN 1306 (and/or one or more other RANs), and the RIC 1304 can be associated with the RAN 1306 (and/or one or more other RANs) via an interface(s) (e.g., an E2 interface or another interface), to facilitate communication of information between the RIC 1304 and the RAN 1306 (and/or one or more other RANs).

The SMO component 1302 can act and operate as a management and orchestration layer that can control configuration and automation aspects of the RIC 1304 and RAN elements of the RAN(s) 1306. The SMO component 1302 can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time.

The RIC 1304 can operate to control (e.g., manage) and enhance (e.g., improve or optimize) RAN functions and services of the RAN(s) 1306. At least some of the various network functions and components of the RIC 1304 can operate in real time or near real time, and some network functions and components of the RIC 1304 may operate in non-real time.

In accordance with various embodiments, the system 1300 can comprise a processor component 1338 that can be associated with (e.g., communicatively connected to) and can work in conjunction with other components of the system 1300, including the SMO 1302, the RIC 1304, the RAN 1306, the DRX manager component 1320, a data store 1340, and/or other components of the system 1300, to facilitate performing the various functions and operations of the system 1300. The processor component 1338 can employ one or more processors (e.g., one or more central processing units (CPUs)), microprocessors, or controllers that can process information relating to data, files, services, applications, communication networks, RANs, cells, devices, users, resources, communication sessions (e.g., PDU or other communication sessions), performance indicators, DRX, long DRX cycles, short DRX cycles, DRX inactivity timers, management of DRX parameters, MAC CE, DCI, RRC signaling, PDB, remaining PDB, AI/ML-based models, measurement reports, threshold (e.g., maximum, minimum, or other threshold) values, PDU sets, grants (e.g., downlink or uplink periodic grants or configured grants), training data, feedback information, congestion information or indicators, data processing operations, messages, notifications, alarms, alerts, preferences (e.g., user or client preferences), hash values, metadata, parameters, traffic flows, policies, the defined DRX management criteria, algorithms (e.g., enhanced DRX management algorithms, enhanced AI/ML-based prediction algorithms, hash algorithms, data compression algorithms, data decompression algorithms, and/or other algorithm), interfaces, protocols, tools, and/or other information, to facilitate operation of the system 1300, and control data flow between the system 1300 and/or other components (e.g., network components, another RAN, the communication network 102, a device (e.g., 110 or 112), a node, a service, a user, or other entity) associated with the system 1300.

The data store 1340 can store data structures (e.g., user data, metadata), code structure(s) (e.g., modules, objects, hashes, classes, procedures) or instructions, information relating to data, files, services, applications, communication networks, RANs, cells, devices, users, resources, communication sessions (e.g., PDU or other communication sessions), performance indicators, DRX, long DRX cycles, short DRX cycles, DRX inactivity timers, management of DRX parameters, MAC CE, DCI, RRC signaling, PDB, remaining PDB, AI/ML-based models, measurement reports, threshold (e.g., maximum, minimum, or other threshold) values, PDU sets, grants (e.g., downlink or uplink periodic grants or configured grants), training data, feedback information, congestion information or indicators, data processing operations, messages, notifications, alarms, alerts, preferences (e.g., user or client preferences), hash values, metadata, parameters, traffic flows, policies, the defined DRX management criteria, algorithms (e.g., enhanced DRX management algorithms, enhanced AI/ML-based prediction algorithms, hash algorithms, data compression algorithms, data decompression algorithms, and/or other algorithm), interfaces, protocols, tools, and/or other information, to facilitate controlling or performing operations associated with the system 1300. The data store 1340 can comprise volatile and/or non-volatile memory, such as described herein. In an aspect, the processor component 1338 can be functionally coupled (e.g., through a memory bus) to the data store 1340 in order to store and retrieve information desired to operate and/or confer functionality, at least in part, to the SMO 1302, RIC 1304, RAN 1306, DRX manager component 1320, processor component 1338, data store 1340, and/or other component of the system 1300, and/or substantially any other operational aspects of system 1300.

As disclosed, the data store 1340 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

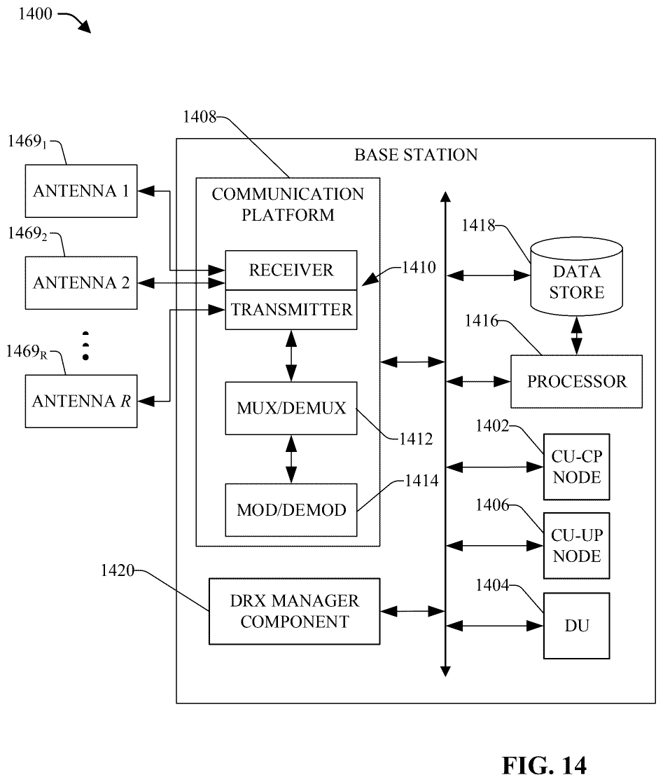

Turning to FIG. 14, FIG. 14 depicts a diagram of a non-limiting example base station 1400 that can desirably facilitate (e.g., enable) connections (e.g., wireless connections) and communication of information associated with devices, in accordance with various aspects and embodiments of the disclosed subject matter. In some embodiments, the base station 1400 can be a 5G or other NR base station (e.g., gNB or other NR-type or xG base station, wherein x can be a number greater than 5). In other embodiments, the base station 1400 can be a 4G or LTE base station, or some other type of base station (e.g., other type of access point).

With regard to a 5G or other NR base station, the base station 1400 can comprise a CU-CP node 1402 (e.g., a gNB or other NR-NB CU-CP node), one or more DUs (e.g., a gNB or other NR-NB DUs), including DU 1404, a desired number of CU-UP nodes (e.g., a gNB or other NR-NB CU-UP nodes), including CU-UP node 1406, and/or other network equipment. The CU-CP node 1402 can be associated or interfaced with the DUs (e.g., DU 1404) via an interface (e.g., F1-C interface) or connection. The CU-CP node 1402 can be associated or interfaced with the CU-UP nodes (e.g., CU-UP node 1406) via an interface (e.g., E1 interface) or connection. The one or more CU-UP nodes (e.g., CU-UP node 1406) can be associated or interfaced with the one or more DUs (e.g., DU 1404) via an interface (e.g., F1-U interface) or connection.

A DU (e.g., DU 1404) can provide support for lower layers of a protocol stack. For instance, a DU (e.g., DU 1404) can be a logical node that can host or handle baseband (e.g., PHY) and L2 (e.g., MAC and RLC layer) functionality associated with the base station 1400. A CU-UP node (e.g., CU-UP node 1406) can be a logical node that can host or handle data traffic between the core network 104 (e.g., 5G or other NR or xG core network) and the DU(s) (e.g., DU 1404) to which the particular CU-UP is connected. The CU-CP node 1402 can be a logical node that can host or handle L3 (e.g., RRC and PDCP layer) control plane functionality associated with the base station 1400.

In some embodiments, a device(s) (e.g., device(s) 110 and/or 112) can be connected to the base station 1400, via the DU 1404, wherein the CU-UP node 1406 and the DU 1404 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the data source) via the base station 1400.

The base station 1400 can receive and transmit signal(s) from and to wireless devices like access points (e.g., base stations, femtocells, picocells, or other type of access point), access terminals (e.g., UEs), wireless ports and routers, and the like, through a set of antennas 14691-1469R. In an aspect, the antennas 14691-1469R can be a part of a communication platform 1408, which comprises electronic components and associated circuitry that can provide for processing and manipulation of received signal(s) and signal(s) to be transmitted. In an aspect, the communication platform 1408 can include a receiver/transmitter 1410 that can convert signal from analog to digital upon reception, and from digital to analog upon transmission. In addition, receiver/transmitter 1410 can divide a single data stream into multiple, parallel data streams, or perform the reciprocal operation. In accordance with various embodiments, the communication platform 1408 can be, can comprise, or can be associated with an RU (e.g., a gNB or other NR-NB RU node).

In an aspect, coupled to receiver/transmitter 1410 can be a multiplexer/demultiplexer (mux/demux) 1412 that can facilitate manipulation of signal in time and frequency space. The mux/demux 1412 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 1412 can scramble and spread information (e.g., codes) according to substantially any code known in the art, e.g., Hadamard-Walsh codes, Baker codes, Kasami codes, polyphase codes, and so on. A modulator/demodulator (mod/demod) 1414 also can be part of the communication platform 1408, and can modulate information according to multiple modulation techniques, such as frequency modulation, amplitude modulation (e.g., M-ary quadrature amplitude modulation (QAM), with M a positive integer), phase-shift keying (PSK), and the like.

The base station 1400 also can comprise a processor(s) 1416 that can be configured to confer and/or facilitate providing functionality, at least partially, to substantially any electronic component in or associated with the base station 1400. For instance, the processor(s) 1416 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 1400 can include a data store 1418 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters) associated with devices; information relating to data, files, services, applications, communication networks, RANs, cells, users, resources, communication sessions, performance indicators, DRX, long DRX cycles, short DRX cycles, DRX inactivity timers, management of DRX parameters, MAC CE, DCI, RRC signaling, PDB, remaining PDB, AI/ML-based models, measurement reports, threshold (e.g., maximum, minimum, or other threshold) values, PDU sets, grants (e.g., downlink or uplink periodic grants or configured grants), training data, feedback information, congestion information or indicators, data processing operations, messages, notifications, alarms, alerts, preferences (e.g., user or client preferences), hash values, metadata, parameters, traffic flows, policies, the defined DRX management criteria, algorithms (e.g., enhanced DRX management algorithms, enhanced AI/ML-based prediction algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on. The processor(s) 1416 can employ one or more processors (e.g., one or more CPUs), microprocessors, or controllers) that can process information, and can be coupled to the data store 1418 in order to store and retrieve at least some of the information (e.g., information, such as algorithms, relating to multiplexing/demultiplexing or modulation/demodulation; information relating to radio link levels; information relating to data, files, services, applications, communication networks, RANs, cells, devices, users, resources, communication sessions, performance indicators, DRX, long DRX cycles, short DRX cycles, DRX inactivity timers, management of DRX parameters, MAC CE, DCI, RRC signaling, PDB, remaining PDB, AI/ML-based models, measurement reports, threshold (e.g., maximum, minimum, or other threshold) values, PDU sets, grants (e.g., downlink or uplink periodic grants or configured grants), training data, feedback information, congestion information or indicators, data processing operations, messages, notifications, alarms, alerts, preferences (e.g., user or client preferences), hash values, metadata, parameters, traffic flows, policies, the defined DRX management criteria, algorithms (e.g., enhanced DRX management algorithms, enhanced AI/ML-based prediction algorithms, hash algorithms, data compression algorithms, data decompression algorithms, and/or other algorithm), interfaces, protocols, tools, and/or other information) desired to operate and/or confer functionality to the communication platform 1408 and/or other operational components of the base station 1400.

The data store 1418 can comprise volatile memory and/or nonvolatile memory. By way of example and not limitation, nonvolatile memory can include ROM, PROM, EPROM, EEPROM, flash memory, NVMe, NVMe-oF, PMEM, or PMEM-oF. Volatile memory can include RAM, which can act as external cache memory. By way of example and not limitation, RAM can be available in many forms such as SRAM, DRAM, SDRAM, DDR SDRAM, ESDRAM, SLDRAM, and DRRAM. Memory of the disclosed aspects are intended to comprise, without being limited to, these and other suitable types of memory.

In accordance with various embodiments, the base station 1400 can comprise a DRX manager component 1420 that can be associated with (e.g., communicatively connected to or part of) the CU-CP 1402, DU 1404, the CU-UP 1406, and/or another component of or associated with the base station 1400. In some embodiments, the DRX manager component 1420 can be a separate component in the base station 1400 (as depicted in FIG. 14), and can be associated with the DU 1404 and/or one or more of the other components of the base station 1400. In other embodiments, the DRX manager component 1420 can be part of the DU 1404. In still other embodiments, the DRX manager component 1420 can be part of another component of or associated with the base station 1400. The DRX manager component 1420 can comprise various components and functions, and can perform various operations, such as described herein

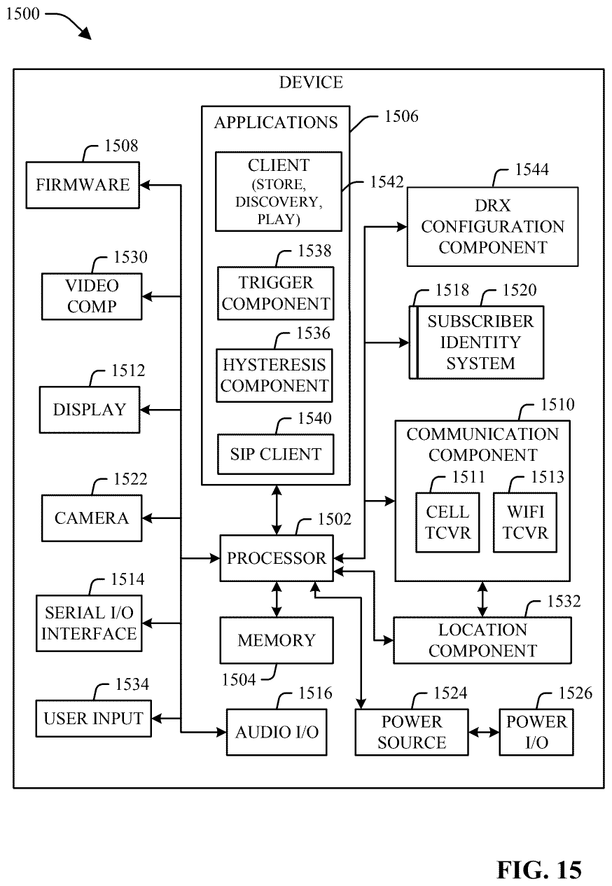

Referring to FIG. 15, FIG. 15 illustrates a diagram of a non-limiting example device 1500 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 1500 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 1500, can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 1500 can include a processor(s) 1502 for controlling and processing all onboard operations and functions. The processor(s) 1502 can comprise one or more processors (e.g., one or more central processing units (CPUs)), microprocessors, or controllers) that can process information associated with the device 1500. A memory 1504 can interface to the processor(s) 1502 for storage of data and one or more applications 1506 (e.g., a video player software, user feedback component software, etc.). Other applications can include voice recognition of predetermined voice commands that facilitate initiation of the user feedback signals. The applications 1506 can be stored in the memory 1504 and/or in a firmware 1508, and executed by the processor(s) 1502 from either or both the memory 1504 or/and the firmware 1508. The firmware 1508 can also store startup code for execution in initializing the device 1500. A communication component 1510 interfaces to the processor(s) 1502 to facilitate wired/wireless communication with external systems, e.g., cellular networks, VoIP networks, and so on. Here, the communication component 1510 can also include a suitable cellular transceiver 1511 (e.g., a global system for mobile communication (GSM), orthogonal frequency division multiple access (OFDMA), 4G, LTE, 5G, other NR, or other type of transceiver) and/or an unlicensed transceiver 1513 (e.g., Wi-Fi, WiMax) for corresponding signal communications. The device 1500 can be a device such as a cellular telephone, a PDA with mobile communications capabilities, and messaging-centric devices. The communication component 1510 also facilitates communications reception from terrestrial radio networks (e.g., broadcast), digital satellite radio networks, and Internet-based radio services networks.

The device 1500 includes a display 1512 for displaying text, images, video, telephony functions (e.g., a Caller ID function), setup functions, and for user input. For example, the display 1512 can also be referred to as a “screen” that can accommodate the presentation of multimedia content (e.g., music metadata, messages, wallpaper, graphics, etc.). The display 1512 can also display videos and can facilitate the generation, editing and sharing of video quotes. A serial I/O interface 1514 is provided in communication with the processor(s) 1502 to facilitate wired and/or wireless serial communications (e.g., USB, and/or IEEE 1394) through a hardwire connection, and other serial input devices (e.g., a keyboard, keypad, and mouse). This supports updating and troubleshooting the device 1500, for example. Audio capabilities are provided with an audio I/O component 1516, which can include a speaker for the output of audio signals related to, for example, indication that the user pressed the proper key or key combination to initiate the user feedback signal. The audio I/O component 1516 also facilitates the input of audio signals through a microphone to record data and/or telephony voice data, and for inputting voice signals for telephone conversations.

The device 1500 can include a slot interface 1518 for accommodating a SIC (Subscriber Identity Component) in the form factor of a card Subscriber Identity Module (SIM) or universal SIM 1520, and interfacing the SIM card 1520 with the processor(s) 1502. However, it is to be appreciated that the SIM card 1520 can be manufactured into the device 1500, and updated by downloading data and software.

The device 1500 can process IP data traffic through the communication component 1510 to accommodate IP traffic from an IP network such as, for example, the Internet, a corporate intranet, a home network, a person area network, etc., through an ISP or broadband cable provider. Thus, VOIP traffic can be utilized by the device 1500 and IP-based multimedia content can be received in either an encoded or a decoded format.

A video processing component 1522 (e.g., a camera) can be provided for decoding encoded multimedia content. The video processing component 1522 can aid in facilitating the generation, editing, and sharing of video quotes. The device 1500 also includes a power source 1524 in the form of batteries and/or an AC power subsystem, which power source 1524 can interface to an external power system or charging equipment (not shown) by a power I/O component 1526.

The device 1500 can also include a video component 1530 for processing video content received and, for recording and transmitting video content. For example, the video component 1530 can facilitate the generation, editing and sharing of video quotes. A location tracking component 1532 facilitates geographically locating the device 1500. As described hereinabove, this can occur when the user initiates the feedback signal automatically or manually. A user input component 1534 facilitates the user initiating the quality feedback signal. The user input component 1534 can also facilitate the generation, editing and sharing of video quotes. The user input component 1534 can include such conventional input device technologies such as a keypad, keyboard, mouse, stylus pen, and/or touch screen, for example.

Referring again to the applications 1506, a hysteresis component 1536 facilitates the analysis and processing of hysteresis data, which is utilized to determine when to associate with the access point. A software trigger component 1538 can be provided that facilitates triggering of the hysteresis component 1536 when the Wi-Fi transceiver 1513 detects the beacon of the access point. A SIP client 1540 enables the device 1500 to support SIP protocols and register the subscriber with the SIP registrar server. The applications 1506 can also include a client 1542 that provides at least the capability of discovery, play and store of multimedia content, for example, music.

The device 1500, as indicated above related to the communication component 1510, includes an indoor network radio transceiver 1513 (e.g., Wi-Fi transceiver). This function supports the indoor radio link, such as IEEE 802.11, for the dual-mode GSM device (e.g., device 1500). The device 1500 can accommodate at least satellite radio services through a device (e.g., handset device) that can combine wireless voice and digital radio chipsets into a single device (e.g., single handheld device).

In some embodiments, the device 1500 can comprise a DRX configuration component 1544 that can configure or modify (e.g., reconfigure) a long DRX cycle, enable, disable, configure or modify a short DRX cycle, configure or modify a DRX inactivity timer, and/or configure or modify another DRX parameter, feature, or component, based at least in part on respective DRX parameter values that can be received from the RAN (e.g., employing the DRX manager component) via RRC signaling, MAC CE, or DCI, such as described herein.

It is to be appreciated and understood that one or more components (e.g., the devices, configuration manager component, base station, core network, or other component) of the systems (e.g., system 100, system 1300, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

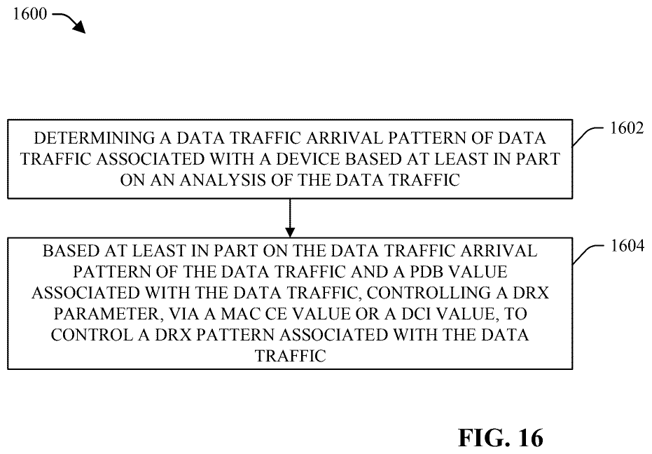

In view of the example systems and/or devices described herein, example methods that can be implemented in accordance with the disclosed subject matter can be further appreciated with reference to flowcharts in FIGS. 16-19. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 16 illustrates a flow chart of an example method 1600 that can desirably (e.g., automatically, dynamically, suitably, reliably, efficiently, enhancedly, and/or optimally) manage DRX associated with a device to achieve desirable communication performance and power savings, in accordance with various aspects and embodiments of the disclosed subject matter. The method 1600 can be employed by, for example, a system comprising the DRX manager component that can comprise or be associated with the processor component, the data store, and/or other components.

At 1602, a data traffic arrival pattern of data traffic associated with a device can be determined based at least in part on an analysis of the data traffic. For instance, the DRX manager component can analyze the data traffic associated with the device (e.g., data traffic being communicated to and received by the device). Based at least in part on the results of such analysis, the DRX manager component can determine (e.g., identify) the data traffic arrival pattern of data traffic associated with the device.

At 1604, based at least in part on the data traffic arrival pattern of the data traffic and a PDB value associated with the data traffic, a DRX parameter can be controlled, via a MAC CE value or a DCI value, to control a DRX pattern associated with the data traffic. The DRX manager component can control (e.g., manage, modify, adjust, or reconfigure), via the MAC CE value or the DCI value (e.g., communicated to the device to facilitate controlling), the DRX parameter to control the DRX pattern associated with the data traffic, such as described herein.

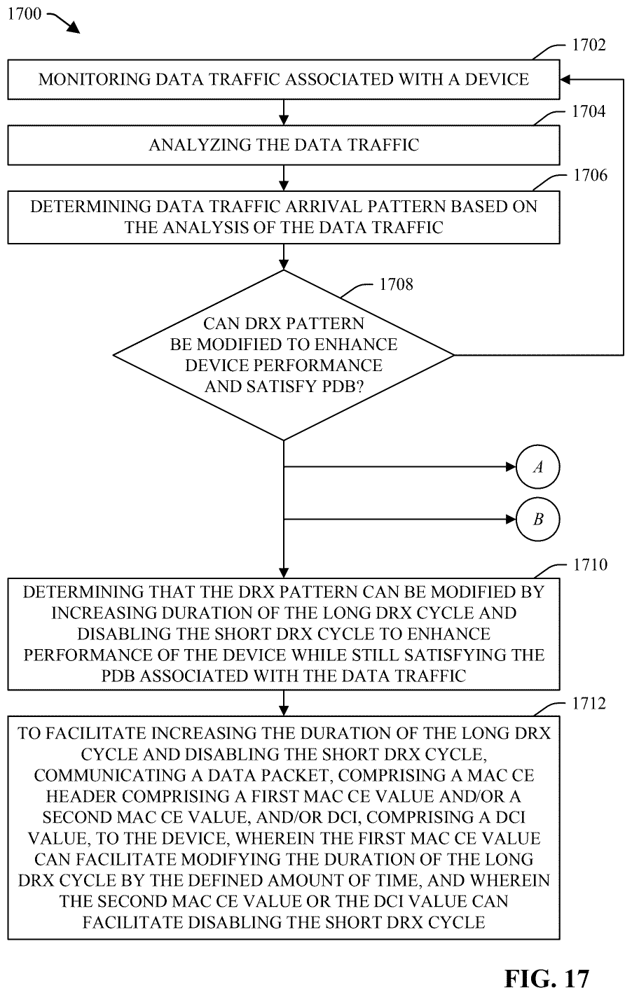

FIG. 17 depicts a flow chart of an example method 1700 that can desirably (e.g., automatically, dynamically, suitably, reliably, efficiently, enhancedly, and/or optimally) manage DRX associated with a device, including managing modification of a long DRX cycle and/or short DRX cycle associated with data traffic associated with the device, to achieve desirable communication performance and power savings, in accordance with various aspects and embodiments of the disclosed subject matter. The method 1700 can be employed by, for example, a system comprising the DRX manager component that can comprise or be associated with the processor component, the data store, and/or other components.

At 1702, data traffic associated with a device can be monitored. At 1704, the data traffic associated with the device can be analyzed. At 1706, a data traffic arrival pattern of data traffic associated with a device can be determined based at least in part on the analysis of the data traffic. For instance, the DRX manager component can monitor and analyze the data traffic associated with the device (e.g., data traffic being communicated to and received by the device). Based at least in part on the results of such analysis, the DRX manager component can determine (e.g., identify) the data traffic arrival pattern of data traffic associated with (e.g., arriving at) the device.

At 1708, a determination can be made regarding whether a DRX pattern associated with the device can be modified to enhance performance of the device while still satisfying the PDB associated with the data traffic based at least in part on the results of analyzing the DRX pattern, the data traffic arrival pattern, and the PDB. For instance, the DRX manager component can determine whether the DRX pattern associated with the DRX associated with the device can be modified to enhance performance of the device while still satisfying (e.g., meeting; being less than or equal to) the PDB (e.g., the PDB value) associated with (e.g., applicable to) the data traffic based at least in part on the results of analyzing the DRX pattern, the data traffic arrival pattern, and the PDB.

If, at 1708, it is determined that there is no modification that can be made to the DRX pattern to enhance performance of the device while still satisfying the PDB associated with the data traffic, the method 1700 can return to reference numeral 1702, wherein the data traffic (e.g., subsequent data traffic) associated with the device can continue to be monitored, and the method 1700 can proceed from that point. For example, if, based at least in part on the results of analyzing the DRX pattern, the data traffic arrival pattern, and the PDB, the DRX manager component determines that there is no modification that can be made to the DRX pattern to enhance performance of the device while still satisfying the PDB associated with the data traffic, the DRX manager component can determine that no modification is to be made to the DRX pattern (at least at this time), and the DRX manager component can continue to monitor and analyze the data traffic associated with the device.

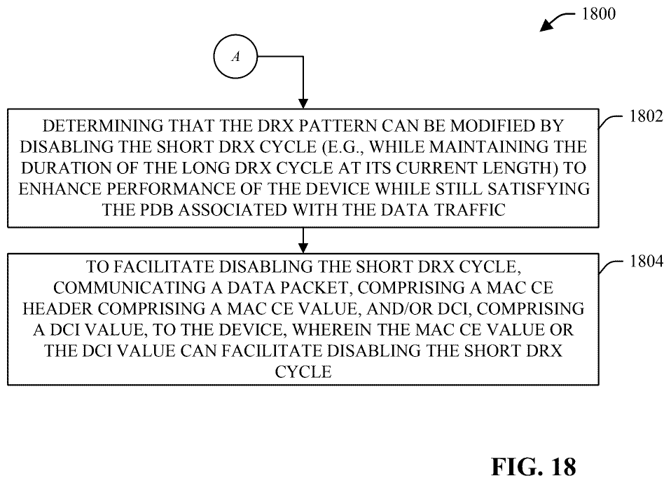

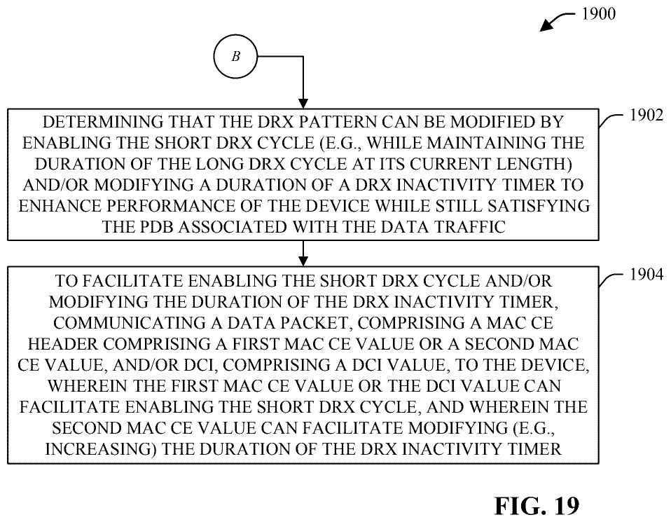

If, instead, at 1708, it is determined that the DRX pattern can be modified to enhance performance of the device while still satisfying the PDB associated with the data traffic, in accordance with various embodiments, the method 1700 can proceed to reference numeral 1710, can proceed to reference point A, or can proceed to reference point B. In some embodiments, a method 1800, as depicted in FIG. 18 and described herein, can proceed from reference point A. In certain other embodiments, a method 1900, as depicted in FIG. 19 and described herein, can proceed from reference point B.

At 1710, a determination can be made that the DRX pattern can be modified by increasing duration of the long DRX cycle and disabling the short DRX cycle to enhance performance of the device while still satisfying the PDB associated with the data traffic. For example, based at least in part on the results of analyzing the DRX pattern, the data traffic arrival pattern, and the PDB, the DRX manager component can determine that increasing the duration of the long DRX cycle by a defined amount of time and disabling the short DRX cycle (e.g., where the short DRX cycled had been enabled) can enhance performance of the device (e.g., reduce power consumption or otherwise enhance performance of the device) while still satisfying the PDB associated with the data traffic.

At 1712, to facilitate increasing the duration of the long DRX cycle and disabling the short DRX cycle, a data packet, comprising a MAC CE header comprising a first MAC CE value and/or a second MAC CE value, and/or DCI, comprising a DCI value, can be communicated to the device, wherein the first MAC CE value can facilitate modifying the duration of the long DRX cycle by the defined amount of time, and wherein the second MAC CE value or the DCI value can facilitate disabling the short DRX cycle. In accordance with various embodiments, the DRX manager component can generate the data packet comprising the MAC CE header comprising the first MAC CE value and/or the second MAC CE value, and/or can generate the DCI comprising the DCI value. The first MAC CE value can be representative of or can correspond to the increase of the duration of the long DRX cycle by the defined amount of time to a modified long DRX cycle at the device. The second MAC CE value or the DCI value can be representative of or can correspond to a disable value that can facilitate disabling the short DRX cycle at the device. The DRX manager component can communicate the data packet, comprising the MAC CE header, comprising the first MAC CE value and/or the second MAC CE value, and/or can communicate the DCI, comprising the DCI value, to the device.

The device can receive the data packet and/or the DCI from the DRX manager component. The device can modify the duration of the long DRX cycle to the modified longer DRC cycle based at least in part on the first MAC CE value. The device also can disable the short DRX cycle based at least in part on the second MAC CE value or the DCI value.

FIG. 18 illustrates a flow chart of another example method 1800 that can desirably (e.g., automatically, dynamically, suitably, reliably, efficiently, enhancedly, and/or optimally) manage DRX associated with a device, including managing disabling of a short DRX cycle associated with data traffic associated with the device, to achieve desirable communication performance and power savings, in accordance with various aspects and embodiments of the disclosed subject matter. The method 1800 can be employed by, for example, a system comprising the DRX manager component that can comprise or be associated with the processor component, the data store, and/or other components. In some embodiments, the method 1800 can proceed from reference point A.

At 1802, a determination can be made that the DRX pattern can be modified by disabling the short DRX cycle (e.g., while maintaining the duration of the long DRX cycle at its current length) to enhance performance of the device while still satisfying the PDB associated with the data traffic. For example, based at least in part on the results of analyzing the DRX pattern, the data traffic arrival pattern, and the PDB, the DRX manager component can determine that disabling the short DRX cycle (e.g., where the short DRX cycled had been enabled), while maintaining the duration of the long DRX cycle at its current length, can enhance performance of the device (e.g., reduce power consumption or otherwise enhance performance of the device) while still satisfying the PDB associated with the data traffic.

At 1804, to facilitate disabling the short DRX cycle, a data packet, comprising a MAC CE header comprising a MAC CE value, and/or DCI, comprising a DCI value, can be communicated to the device, wherein the MAC CE value or the DCI value can facilitate disabling the short DRX cycle. In accordance with various embodiments, the DRX manager component can generate the data packet comprising the MAC CE header comprising the MAC CE value, and/or can generate the DCI comprising the DCI value. The MAC CE value or the DCI value can be representative of or can correspond to a disable value that can facilitate disabling the short DRX cycle at the device. The DRX manager component can communicate the data packet, comprising the MAC CE header, comprising the MAC CE value, and/or can communicate the DCI, comprising the DCI value, to the device.

The device can receive the data packet or the DCI from the DRX manager component. The device can disable the short DRX cycle based at least in part on the MAC CE value or the DCI value.

FIG. 19 depicts a flow chart of another example method 1900 that can desirably (e.g., automatically, dynamically, suitably, reliably, efficiently, enhancedly, and/or optimally) manage DRX associated with a device, including managing modification of a short DRX cycle and/or a DRX inactivity timer associated with data traffic associated with the device, to achieve desirable communication performance and power savings, in accordance with various aspects and embodiments of the disclosed subject matter. The method 1900 can be employed by, for example, a system comprising the DRX manager component that can comprise or be associated with the processor component, the data store, and/or other components. In some embodiments, the method 1900 can proceed from reference point B.

At 1902, a determination can be made that the DRX pattern can be modified by enabling the short DRX cycle (e.g., while maintaining the duration of the long DRX cycle at its current length) and/or modifying a duration of a DRX inactivity timer to enhance performance of the device while still satisfying the PDB associated with the data traffic. For example, based at least in part on the results of analyzing the DRX pattern, the data traffic arrival pattern, and the PDB, the DRX manager component can determine that enabling the short DRX cycle (e.g., where the short DRX cycled had been disabled) and/or modifying (e.g., increasing) the duration of the DRX inactivity timer associated with the device, while maintaining the duration of the long DRX cycle at its current length, can enhance performance of the device (e.g., reduce power consumption or otherwise enhance performance of the device) while still satisfying the PDB associated with the data traffic.

At 1904, to facilitate enabling the short DRX cycle and/or modifying the duration of the DRX inactivity timer, a data packet, comprising a MAC CE header comprising a first MAC CE value or a second MAC CE value, and/or DCI, comprising a DCI value, can be communicated to the device, wherein the first MAC CE value or the DCI value can facilitate enabling the short DRX cycle, and wherein the second MAC CE value can facilitate modifying (e.g., increasing) the duration of the DRX inactivity timer. In accordance with various embodiments, the DRX manager component can generate the data packet comprising the MAC CE header comprising the first MAC CE value or the second MAC CE value, and/or can generate the DCI comprising the DCI value. The first MAC CE value or the DCI value can be representative of or can correspond to an enable value that can facilitate enabling the short DRX cycle at the device. The second MAC CE value can be representative of or can correspond to modifying (e.g., increasing) the duration of the DRX inactivity timer to a desired modified duration (e.g., a desired modified DRX inactivity timer value). The DRX manager component can communicate the data packet, comprising the MAC CE header, comprising the first MAC CE value or the second MAC CE value, and/or can communicate the DCI, comprising the DCI value, to the device.

The device can receive the data packet or the DCI from the DRX manager component. The device can enable the short DRX cycle based at least in part on the first MAC CE value or the DCI value, and/or can modify (e.g., increase) the duration of the DRX inactivity timer to the desired modified duration (e.g., the desired modified DRX inactivity timer value) based at least in part on the second MAC CE value.

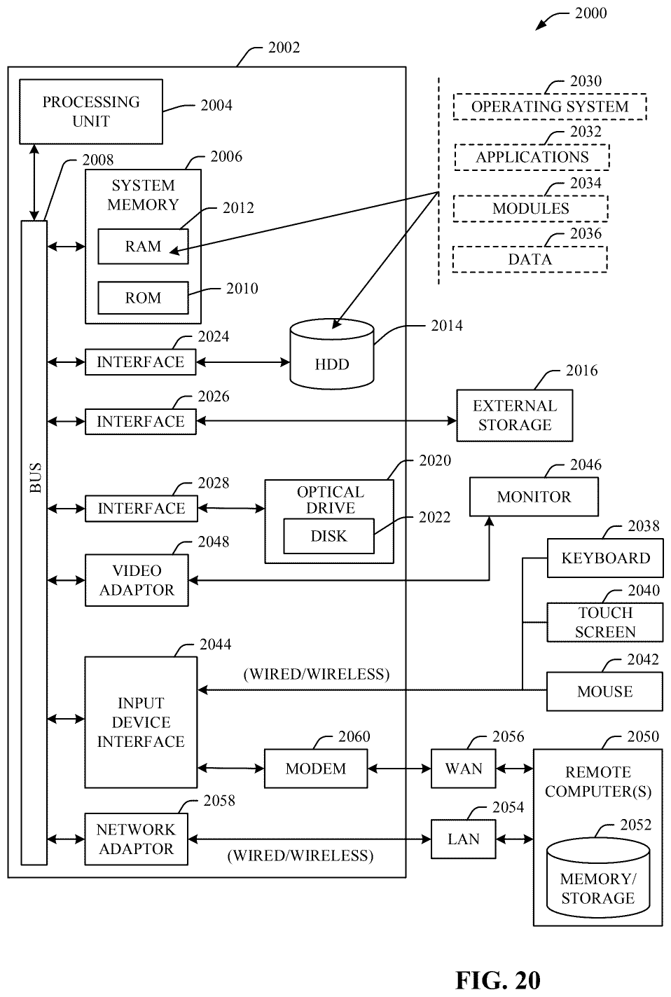

In order to provide additional context for various embodiments described herein, FIG. 20 and the following discussion are intended to provide a brief, general description of a suitable computing environment 2000 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 20, the example environment 2000 for implementing various embodiments of the aspects described herein includes a computer 2002, the computer 2002 including a processing unit 2004, a system memory 2006 and a system bus 2008. The system bus 2008 couples system components including, but not limited to, the system memory 2006 to the processing unit 2004. The processing unit 2004 can be any of various commercially available processors. Dual microprocessors and other multi-processor architectures can also be employed as the processing unit 2004.

The system bus 2008 can be any of several types of bus structure that can further interconnect to a memory bus (with or without a memory controller), a peripheral bus, and a local bus using any of a variety of commercially available bus architectures. The system memory 2006 includes ROM 2010 and RAM 2012. A basic input/output system (BIOS) can be stored in a non-volatile memory such as ROM, erasable programmable read only memory (EPROM), EEPROM, which BIOS contains the basic routines that help to transfer information between elements within the computer 2002, such as during startup. The RAM 2012 can also include a high-speed RAM such as static RAM for caching data.

The computer 2002 further includes an internal hard disk drive (HDD) 2014 (e.g., EIDE, SATA), one or more external storage devices 2016 (e.g., a magnetic floppy disk drive (FDD) 2016, a memory stick or flash drive reader, a memory card reader, etc.) and an optical disk drive 2020 (e.g., which can read or write from a CD-ROM disc, a DVD, a BD, etc.). While the internal HDD 2014 is illustrated as located within the computer 2002, the internal HDD 2014 also can be configured for external use in a suitable chassis (not shown). Additionally, while not shown in environment 2000, a solid state drive (SSD) could be used in addition to, or in place of, an HDD 2014. The HDD 2014, external storage device(s) 2016 and optical disk drive 2020 can be connected to the system bus 2008 by an HDD interface 2024, an external storage interface 2026 and an optical drive interface 2028, respectively. The interface 2024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2012, including an operating system 2030, one or more application programs 2032, other program modules 2034 and program data 2036. All or portions of the operating system, applications, modules, and/or data can also be cached in the RAM 2012. The systems and methods described herein can be implemented utilizing various commercially available operating systems or combinations of operating systems.

Computer 2002 can optionally comprise emulation technologies. For example, a hypervisor (not shown) or other intermediary can emulate a hardware environment for operating system 2030, and the emulated hardware can optionally be different from the hardware illustrated in FIG. 20. In such an embodiment, operating system 2030 can comprise one virtual machine (VM) of multiple VMs hosted at computer 2002. Furthermore, operating system 2030 can provide runtime environments, such as the Java runtime environment or the NET framework, for applications 2032. Runtime environments are consistent execution environments that allow applications 2032 to run on any operating system that includes the runtime environment. Similarly, operating system 2030 can support containers, and applications 2032 can be in the form of containers, which are lightweight, standalone, executable packages of software that include, e.g., code, runtime, system tools, system libraries and settings for an application.

Further, computer 2002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 2002, e.g., applied at the application execution level or at the operating system (OS) kernel level, thereby enabling security at any level of code execution.

A user can enter commands and information into the computer 2002 through one or more wired/wireless input devices, e.g., a keyboard 2038, a touch screen 2040, and a pointing device, such as a mouse 2042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2004 through an input device interface 2044 that can be coupled to the system bus 2008, but can be connected by other interfaces, such as a parallel port, an IEEE 1394 serial port, a game port, a USB port, an IR interface, a BLUETOOTH® interface, etc.

A monitor 2046 or other type of display device can be also connected to the system bus 2008 via an interface, such as a video adapter 2048. In addition to the monitor 2046, a computer typically includes other peripheral output devices (not shown), such as speakers, printers, etc.

The computer 2002 can operate in a networked environment using logical connections via wired and/or wireless communications to one or more remote computers, such as a remote computer(s) 2050. The remote computer(s) 2050 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2052 is illustrated. The logical connections depicted include wired/wireless connectivity to a local area network (LAN) 2054 and/or larger networks, e.g., a wide area network (WAN) 2056. Such LAN and WAN networking environments are commonplace in offices and companies, and facilitate enterprise-wide computer networks, such as intranets, all of which can connect to a global communications network, e.g., the Internet.

When used in a LAN networking environment, the computer 2002 can be connected to the local network 2054 through a wired and/or wireless communication network interface or adapter 2058. The adapter 2058 can facilitate wired or wireless communication to the LAN 2054, which can also include a wireless access point (AP) disposed thereon for communicating with the adapter 2058 in a wireless mode.

When used in a WAN networking environment, the computer 2002 can include a modem 2060 or can be connected to a communications server on the WAN 2056 via other means for establishing communications over the WAN 2056, such as by way of the Internet. The modem 2060, which can be internal or external and a wired or wireless device, can be connected to the system bus 2008 via the input device interface 2044. In a networked environment, program modules depicted relative to the computer 2002 or portions thereof, can be stored in the remote memory/storage device 2052. It will be appreciated that the network connections shown are example and other means of establishing a communications link between the computers can be used.

When used in either a LAN or WAN networking environment, the computer 2002 can access cloud storage systems or other network-based storage systems in addition to, or in place of, external storage devices 2016 as described above. Generally, a connection between the computer 2002 and a cloud storage system can be established over a LAN 2054 or WAN 2056, e.g., by the adapter 2058 or modem 2060, respectively. Upon connecting the computer 2002 to an associated cloud storage system, the external storage interface 2026 can, with the aid of the adapter 2058 and/or modem 2060, manage storage provided by the cloud storage system as it would other types of external storage. For instance, the external storage interface 2026 can be configured to provide access to cloud storage sources as if those sources were physically connected to the computer 2002.

The computer 2002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, base station, DRX manager component, configuration component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
determining, by a system comprising at least one processor, a data traffic arrival pattern of data traffic associated with a device based on an analysis of the data traffic; and
based on the data traffic arrival pattern of the data traffic and a packet delay budget value associated with the data traffic, controlling, by the system, via a medium-access-control (MAC) control element value or a downlink control information value, a discontinuous reception parameter to control a discontinuous reception pattern associated with the data traffic.

2. The method of claim 1, wherein the controlling comprises: based on the MAC control element value or the downlink control information value, controlling the discontinuous reception parameter to control a first discontinuous reception cycle associated with the discontinuous reception pattern or a second discontinuous reception cycle associated with the discontinuous reception pattern, and wherein a second on state of the second discontinuous reception cycle occurs in between respective first on states of respective consecutive first discontinuous reception cycles, comprising the first discontinuous reception cycle.

3. The method of claim 2, further comprising:
to facilitate the controlling, communicating, by the system, the MAC control element value, as part of a MAC header section of a data packet, to the device; or
to facilitate the controlling, communicating, by the system, the downlink control information value, as part of downlink control information, to the device.

4. The method of claim 2, wherein the discontinuous reception parameter is a first discontinuous reception parameter, wherein the MAC control element value is a first MAC control element value, and wherein the method further comprises:
based on the data traffic arrival pattern and the packet delay budget value, determining, by the system, that the first discontinuous reception cycle is able to be increased to a modified first discontinuous reception cycle that enables the second discontinuous reception cycle to be disabled while satisfying a packet delay budget associated with the data traffic,
wherein the controlling comprises:
modifying the first discontinuous reception parameter to increase the first discontinuous reception cycle to the modified first discontinuous reception cycle based on the first MAC control element value; and
disabling the second discontinuous reception cycle based on the second MAC control element value or the downlink control information value.

5. The method of claim 4, wherein the first discontinuous reception parameter is a cycle duration parameter associated with the first discontinuous reception cycle, and wherein the first MAC control element value represents a cycle duration parameter value of the cycle duration parameter that corresponds to a cycle duration of the modified first discontinuous reception cycle.

6. The method of claim 2, wherein the controlling comprises modifying a third discontinuous reception parameter to modify a start offset of the first discontinuous reception cycle to a modified start offset based on a third MAC control element value that represents a start offset parameter value that corresponds to the modified start offset.

7. The method of claim 2, further comprising:
based on the data traffic arrival pattern and the packet delay budget value, determining, by the system, that the first discontinuous reception cycle is able to satisfy a packet delay budget associated with the data traffic without utilization of the second discontinuous reception cycle,
wherein the controlling comprises disabling the second discontinuous reception cycle based on the MAC control element value or the downlink control information value that represents a disable value that facilitates the disabling.

8. The method of claim 2, wherein the discontinuous reception parameter is a first discontinuous reception parameter, wherein the MAC control element value is a first MAC control element value, and wherein the method further comprises:
based on the data traffic arrival pattern and the packet delay budget value, determining, by the system, that a packet data budget associated with the data traffic is not satisfied,
wherein the controlling comprises: to facilitate satisfying the packet data budget,
modifying the first discontinuous reception parameter to increase or decrease the first discontinuous reception cycle to a modified first discontinuous reception cycle based on the first MAC control element value;
modifying a second discontinuous reception parameter to increase or decrease the second discontinuous reception cycle to a modified second discontinuous reception cycle based on a second MAC control element value;
disabling the second discontinuous reception cycle based on the second MAC control element value or the downlink control information value;
enabling the second discontinuous reception cycle based on the second MAC control element value or the downlink control information value; or
modifying a discontinuous reception inactivity timer value of a discontinuous reception inactivity timer associated with the first discontinuous reception cycle to increase or decrease the discontinuous reception inactivity timer to a modified discontinuous reception inactivity timer based on a third MAC control element value.

9. The method of claim 2, wherein the discontinuous reception parameter is a discontinuous reception inactivity timer parameter associated with a discontinuous reception inactivity timer associated with the first discontinuous reception cycle, and wherein the controlling comprises modifying a discontinuous reception inactivity timer value of the discontinuous reception inactivity timer parameter to increase or decrease the discontinuous reception inactivity timer parameter to a modified discontinuous reception inactivity timer value based on the MAC control element value that corresponds to the modified discontinuous reception inactivity timer value.

10. The method of claim 2, further comprising:
determining, by the system, that the device is capable of supporting the second discontinuous reception cycle and dynamic discontinuous reception functionality based on device capability information received from the device, wherein the device capability information indicates that the device is capable of supporting the second discontinuous reception cycle and the dynamic discontinuous reception functionality, and wherein the dynamic discontinuous reception functionality relates to enabling and disabling of the second discontinuous reception cycle or modification of a duration of the second discontinuous reception cycle.

11. The method of claim 1, further comprising:
determining, by the system, a remaining packet delay budget value of a remaining portion of a packet delay budget associated with the data traffic based on the packet delay budget value, a static value for a core-network packet delay budget, a central unit-user plane delay value, a downlink-data-delivery-status delay value, a distributed unit delay value, or an over-the-air delay value,
wherein the controlling comprises: based on the data traffic arrival pattern and the remaining packet delay budget value, controlling, via the MAC control element value or the downlink control information value, the discontinuous reception parameter to control the discontinuous reception pattern associated with the data traffic.

12. A system, comprising:
at least one memory that stores computer executable components; and
at least one processor that executes computer executable components stored in the at least one memory, wherein the computer executable components comprise:
a data pattern analyzer that determines a data traffic pattern of data traffic associated with a user equipment based on a result of an analysis of the data traffic; and
a discontinuous reception manager that, based on the data traffic pattern and a packet delay budget value associated with the data traffic, manages, via a medium-access-control (MAC) control element value or a downlink control information value, a discontinuous reception parameter to manage a discontinuous reception pattern associated with the data traffic.

13. The system of claim 12, wherein the discontinuous reception manager transmits, to the user equipment, a data packet, comprising a MAC header section comprising the MAC control element value, or downlink control information, comprising the downlink control information value,
wherein, based on the transmission of the MAC control element value or the downlink control information value to the user equipment, the discontinuous reception manager manages the discontinuous reception parameter to manage a long discontinuous reception cycle associated with the discontinuous reception pattern or a short discontinuous reception cycle associated with the discontinuous reception pattern, and wherein a second on state of the short discontinuous reception cycle occurs in between respective first on states of respective consecutive long discontinuous reception cycles, comprising the long discontinuous reception cycle.

14. The system of claim 13, wherein the discontinuous reception parameter is a first discontinuous reception parameter, wherein the MAC control element value is a first MAC control element value, wherein, based on the data traffic pattern and the packet delay budget value, the discontinuous reception manager determines that the long discontinuous reception cycle is able to be increased to a reconfigured long discontinuous reception cycle that enables the short discontinuous reception cycle to be disabled without exceeding a packet delay budget represented by the packet delay budget value, and
wherein the discontinuous reception manager reconfigures the long discontinuous reception parameter to increase the long discontinuous reception cycle to the reconfigured long discontinuous reception cycle based on the first MAC control element value, and disables the short discontinuous reception cycle based on the second MAC control element value or the downlink control information value.

15. The system of claim 14, wherein the long discontinuous reception parameter is a cycle duration parameter associated with the long discontinuous reception cycle, and wherein the first MAC control element value represents a cycle duration parameter value of the cycle duration parameter that corresponds to a cycle duration of the reconfigured long discontinuous reception cycle.

16. The system of claim 13, wherein, based on the data traffic pattern and the packet delay budget value, the discontinuous reception manager determines that the long discontinuous reception cycle is able to satisfy a packet delay budget associated with the data traffic without utilization of the short discontinuous reception cycle, and
wherein, in response to determining that the long discontinuous reception cycle is able to satisfy the packet delay budget without utilization of the short discontinuous reception cycle, the discontinuous reception manager disables the short discontinuous reception cycle based on the MAC control element value or the downlink control information value that corresponds to a disable value that facilitates the disabling.

17. The system of claim 13, wherein the discontinuous reception parameter is a discontinuous reception inactivity timer parameter associated with a discontinuous reception inactivity timer associated with the long discontinuous reception cycle, and wherein the discontinuous reception manager reconfigures a discontinuous reception inactivity timer value of the discontinuous reception inactivity timer parameter to increase or decrease the discontinuous reception inactivity timer parameter to a reconfigured discontinuous reception inactivity timer value based on the MAC control element value that corresponds to the reconfigured discontinuous reception inactivity timer value.

18. The system of claim 12, wherein the discontinuous reception manager determines a remaining packet delay budget value of a remaining portion of a packet delay budget associated with the data traffic as a function of the packet delay budget value, a core-network packet delay budget value, a central unit-user plane delay value, a downlink-data-delivery-status delay value, a distributed unit delay value, or an over-the-air delay value, and
wherein, based on the data traffic pattern and the remaining packet delay budget value, the discontinuous reception manager manages, via the MAC control element value or the downlink control information value, the discontinuous reception parameter to manage the discontinuous reception pattern associated with the data traffic.

19. A non-transitory machine-readable medium, comprising executable instructions that, when executed by at least one processor, facilitate performance of operations, comprising:
determining a data traffic arrival pattern of data traffic associated with a user equipment based on a result of an analysis of the data traffic; and
based on the data traffic arrival pattern of the data traffic and a packet delay budget value associated with the data traffic, controlling, via a medium-access-control (MAC) control element value or a downlink control information value, a discontinuous reception parameter to control a discontinuous reception pattern associated with the data traffic.

20. The non-transitory machine-readable medium of claim 19, wherein the discontinuous reception parameter is a first discontinuous reception parameter, wherein the MAC control element value is a first MAC control element value, and wherein the operations further comprise:
based on the data traffic arrival pattern and the packet delay budget value, determining that a packet data budget associated with the data traffic is not satisfied,
wherein the controlling comprises: to facilitate satisfying the packet data budget,
adjusting the first discontinuous reception parameter to increase or decrease a first discontinuous reception cycle associated with the discontinuous reception pattern to an adjusted first discontinuous reception cycle based on the first MAC control element value;
adjusting a second discontinuous reception parameter to increase or decrease a second discontinuous reception cycle associated with the discontinuous reception pattern to an adjusted second discontinuous reception cycle based on a second MAC control element value, wherein a second on state of the second discontinuous reception cycle occurs in between respective first on states of respective consecutive first discontinuous reception cycles, comprising the first discontinuous reception cycle;
disabling the second discontinuous reception cycle based on the second MAC control element value or the downlink control information value;
enabling the second discontinuous reception cycle based on the second MAC control element value or the downlink control information value; or
adjusting a discontinuous reception inactivity timer value of a discontinuous reception inactivity timer associated with the first discontinuous reception cycle to increase or decrease the discontinuous reception inactivity timer to an adjusted discontinuous reception inactivity timer based on a third MAC control element value.
